(19) United States
(12) Patent Application Publication
(10) Pub. No.: US 2017/0230462 A1
(43) Pub. Date: Aug. 10, 2017

(54) Device and Method for Administering a Network

(71) Applicants: Gerd Ascheid, Aachen (DE); Ramin Lavae Mokhtari, Potsdam (DE)

(72) Inventors: Gerd Ascheid, Aachen (DE); Ramin Lavae Mokhtari, Potsdam (DE)

(73) Assignee: ICE Gateway GmbH, Berlin (DE)

(21) Appl. No.: 15/460,498

(22) Filed: Mar. 16, 2017

Related U.S. Application Data
(63) Continuation of application No. PCT/EP2015/061131, filed on May 20, 2015.

(30) Foreign Application Priority Data
Sep. 16, 2014 (DE) 10 2014 113 336.6

(51) Int. Cl. H04L 29/08; H04L 29/06

(52) U.S. Cl. CPC H04L 67/125; H04L 67/28; H04L 63/104

(57) ABSTRACT

Inter alia, a method is disclosed that includes the steps of receiving a first information item wherein the first information item originates from one or a plurality of entities of an internal network, providing the first information item and/or an information item based on the first information item at least partially as a function of an allocation of an information type of the first information item and/or the information item based on the first information item to a first group of entities of an external network such that the first information item and/or the information item based on the first information item is only obtainable by the entities of the first group of entities of the external network.

### CROSS-REFERENCE TO RELATED PATENT APPLICATIONS

This patent application is a continuation of PCT/EP2015/061131, filed May 20, 2015, which claims priority to German Application No. 10 2014 113 336.6, filed Sep. 16, 2014, the entire teachings and disclosure of which are incorporated herein by reference thereto.

### FIELD OF THE INVENTION

The present invention relates, amongst other things, to a device and to a method for administering a network (e.g. a closed network). For example, the present invention relates to a device and to a method for providing an interface between an internal network and an external network. For example, the present invention relates to a device and to a method for administering and/or controlling the entities of the first group of entities of the internal network. For example, the present invention relates, amongst other things, to a device and to a method for a wireless infrastructure and/or a wired infrastructure (e.g. glass fibres) outdoors (e.g. for light, sensors, devices, Apps, traffic and other web applications).

### BACKGROUND OF THE INVENTION

Modern cities nowadays are growing very quickly and for the first time more than 5 billion people live in cities. The need for infrastructural measures is thus growing rapidly and the competition between cities is increasing. In the prior art, systems for recording information outdoors are for example known as infrastructural measures which comprise one or a plurality of devices having one or a plurality of means for recording information outdoors. Lighting systems are for example further known in the prior art which comprise one or a plurality of remote-controllable devices for controlling a light means. However, a disadvantage of these known systems is the communication with and between the respective devices of the systems. Since this communication takes place via public networks such as the internet such that the communication is particularly vulnerable to attacks (e.g. intercepting, manipulating and/or blocking) by unauthorised third parties.

### SUMMARY OF SOME EXEMPLARY CONFIGURATIONS OF THE PRESENT INVENTION

An object of the present invention is therefore to overcome the above-mentioned disadvantages.

This object is achieved by the subject matter of the main claim and the subordinate claims. Advantageous exemplary configurations of the invention can be inferred from the dependent claims.

According to a first aspect of the invention, a method is disclosed which comprises the following:
receiving a first information item wherein the first information item originates from one or a plurality of entities of an internal network,
providing the first information item and/or an information item based on the first information item at least partially as a function of an allocation of an information type of the first information item and/or the information item based on the first information item to a first group of entities of an external network such that the first information item and/or the information item based on the first information item is only obtainable by the entities of the first group of entities of the external network.

For example, the method according to the first aspect of the invention is a method for providing an interface between the internal network and the external network. For example, the method according to the first aspect of the invention is further a method for selectively providing information items (e.g. use information). For example, the method according to the first aspect of the invention is a method for a wireless infrastructure outdoors (e.g. for light, sensors, devices, Apps and other web applications).

For example, the steps of the method according to the first aspect of the invention are performed and/or controlled by a server (e.g. the first server disclosed below).

According to the first aspect of the invention, a first server is further disclosed which comprises one or a plurality of means configured to at least partially perform and/or control the method according to the first aspect of the invention or respective means to at least partially perform and/or control the steps of the method according to the first aspect of the invention.

For example, the first server is a server to provide an interface between the internal network and the external network. For example, the first server is further a server to selectively provide information items (e.g. use information). For example, the first server is a server for a wireless infrastructure outdoors (e.g. for light, sensors, devices, Apps and other web applications).

In the present case, a server should be understood as hardware (e.g. a server device). A server device for example comprises means which are configured to cause the provision of one or a plurality of services for other programs and/or devices. For example, a server device comprises at least one processor and at least one memory including one or a plurality of server programs with program instructions, wherein the memory and the program instructions are configured to, together with the processor, cause the server device to provide one or a plurality of services to other programs and/or devices.

For example, the first server is a server device. For example, the first server is a first server device comprising means which are configured to perform and/or control the method according to the first aspect of the invention and/or the steps of the method according to the first aspect of the invention. For example, the first server is a first server device comprising at least one processor and at least one memory including one or a plurality of server programs with program instructions, wherein the memory and the program instructions are configured to, together with the at least one processor, cause the first server device to perform and/or control the method according to the first aspect of the invention and/or the steps of the method according to the first aspect of the invention. For example, the first server is a first server device comprising at least one processor and at least one memory including one or a plurality of server programs with program instructions, wherein the memory and the program instructions are configured to, together with the at least one processor, cause the first server to at least partially perform and/or control the following steps:
receiving a first information item wherein the first information item originates from one or a plurality of entities of an internal network,
providing the first information item and/or an information item based on the first information item at least partially as a function of an allocation of an information type of the first information item and/or the information item based on the first information item to a first group of entities of an external network such that the first information item and/or the information item based on the first information item is only obtainable by the entities of the first group of entities of the external network.

In the present case, a processor should be understood for example as control units, microprocessors, micro controller units such as micro controllers, digital signal processors (DSP), application-specific integrated circuits (ASICs) or field programmable gate arrays (FPGAs). The memory, which the program instructions includes, can for example be part of the processor, for example a (non-volatile or volatile) program memory and/or main memory of the processor or a part thereof.

For example, the first server is a first server device further comprising one or a plurality of communication means wherein the communications means are configured to send and/or receive information items. An example of a communication means is a network interface wherein the network interface is configured to send and/or receive information items via one or a plurality of network connections. A network interface for example comprises a network card, an antenna, a network module, a network switch and/or a modem.

According to the first aspect of the invention, a first server program is further disclosed which comprises program instructions which cause a device (e.g. the first server device) to at least partially perform the method and/or the steps of the method according to the first aspect of the invention when the first server program is executed by one or a plurality of processors of the device.

The first server program can for example be distributed via a network (e.g. the internal network and/or the external network). The first server program can be at least partially software and/or firmware of a processor. It can also be implemented at least partially as hardware. The first server program can for example be stored on a computer-readable storage medium, e.g. a tangible, magnetic, electric, electromagnetic, optical and/or other type of storage medium. The storage medium can for example be part of the processor of the first server (e.g. the first server device), for example a (non-volatile or volatile) program memory and/or main memory of the processor or a part thereof.

According to a second aspect of the invention, a method is disclosed which comprises the following:
causing and/or controlling a functional recovery and/or a functional update of one or a plurality of entities of a first group of entities of the internal network.

For example, the method according to the second aspect of the invention is a method for administering and/or controlling the entities of the first group of entities of the internal network. For example, the method according to the first aspect of the invention is a method for a wireless infrastructure outdoors (e.g. for light, sensors, devices, Apps and other web applications).

For example, the steps of the method according to the second aspect of the invention are performed and/or controlled by a server (e.g. the second server disclosed below).

According to the second aspect of the invention, a second server is further disclosed which comprises one or a plurality of means configured to at least partially perform and/or control the method according to the second aspect of the invention or respective means to at least partially perform and/or control the steps of the method according to the second aspect of the invention.

For example, the second server is a server for administering and/or controlling the entities of the first group of entities of the internal network. For example, the second server is a server for a wireless infrastructure outdoors (e.g. for light, sensors, devices, APPS and other web applications).

For example, the second server is a second server device. For example, the second server is a second server device comprising means configured to perform and/or control the method according to the second aspect of the invention and/or the steps of the method according to the second aspect of the invention. For example, the second server is a second server device comprising at least one processor and at least one memory including one or a plurality of server programs with program instructions, wherein the memory and the program instructions are configured to, together with the at least one processor, cause the second server device to perform and/or control the method according to the second aspect of the invention and/or the steps of the method according to the second aspect of the invention. For example, the second server is a second server device comprising at least one processor and at least one memory including one or a plurality of server programs with program instructions, wherein the memory and the program instructions are configured to, together with the at least one processor, cause the second server device to at least partially perform and/or control the following steps:
causing and/or controlling a functional recovery and/or a functional update of one or a plurality of entities of a first group of entities of the internal network.

For example, the second server is a second server device further comprising one or a plurality of communication means wherein the communication means are configured to send and/or receive information items. An example of a communication means is a network interface wherein the network interface is configured to send and/or receive information items via one or a plurality of network connections.

According to a second aspect of the invention, a second server program is further disclosed which comprises program instructions which cause a device (e.g. the second server device) to at least partially perform the method and/or the steps of the method according to the second aspect of the invention when the second server program is executed by one or a plurality of processors of the device.

The second server program can for example be distributed via a network (e.g. the internal network and/or the external network). The second server program can be at least partially software and/or firmware of a processor. It can also be implemented at least partially as hardware. The second server program can for example be stored on a computer-readable storage medium, e.g. a tangible, magnetic, electric, electromagnetic, optical and/or other type of storage medium. The storage medium can for example be part of the processor of the second server device, for example a (non-volatile or volatile) program memory and/or main memory of the processor or a part thereof.

According to a third aspect of the invention, a method is disclosed which comprises the steps of the method according to the first aspect of the invention and the steps of the method according to the second aspect of the invention.

For example, the method according to the third aspect of the invention is a method for providing an interface between the internal network and the external network and for administering and/or controlling the entities of the first group of entities of the internal network. For example, the method according to the third aspect of the invention is a method for a wireless infrastructure outdoors (e.g. for light, sensors, devices, APPS and other web applications).

For example, the steps of the method according to the third aspect of the invention are performed and/or controlled by one or a plurality of servers (e.g. the first server and the second server).

According to a third aspect of the invention, a system is further disclosed which comprises one or a plurality of servers wherein the servers respectively comprise one or a plurality of means which are configured to jointly perform and/or control the method according to the third aspect of the invention and/or the steps of the method according to the third aspect of the invention.

For example, the system according to the third aspect of the invention comprises the first and the second server.

It is for example conceivable for the first server and the second server to be the same server. For example, the above-described first server device and the above-described second server device are the same server device (e.g. a single server device) comprising means which are configured to perform and/or control the method according to the first and second aspect of the invention and/or the steps of the method according to the first and second aspect of the invention. In this case, the system according to the third aspect of the invention comprises at least this server or this server device (e.g. this one single server device).

However, it is also conceivable for the first server and the second server to be at least partially different. For example, the first server device and the second server device are at least partially different. In this case, the system according to the third aspect of the invention comprises at least the first server and the second server that is at least partially different from the first server (e.g. the first server device and the second server device that is at least partially different from the first server device).

According to the third aspect of the invention, a computer program is further disclosed which comprises program instructions which cause a device to at least partially perform the method and/or the steps of the method according to the third aspect of the invention when the computer program is executed by one or a plurality of processors of the device.

The computer program according to the third aspect of the invention can for example be distributed via a network (e.g. the internal network and/or the external network). The computer program according to the third aspect of the invention can be at least partially software and/or firmware of a processor. It can also be implemented at least partially as hardware. The computer program according to the third aspect of the invention can for example be stored on a computer-readable storage medium, e.g. a tangible, magnetic, electric, electromagnetic, optical and/or other type of storage medium. The storage medium can for example be part of a processor for example a (non-volatile or volatile) program memory and/or main memory of the processor or a part thereof.

The properties of the method, the server, the system, the server programs and the computer program according to the invention are described below partially by way of example according to the different aspects of the invention. Insofar as it is not expressly described, the following disclosure should thus equally apply to the different aspects of the invention.

In the present case, receiving an information item should for example be understood as the information item being received by a device. For example, an information item can be received by a device via a network connection.

For example, the first information item is received by one of the first server and/or the first server device. For example, the first information item is received via one or a plurality of the network connections of the internal network. For example, the first information item is received by an entity of the internal network. For example, the first server device comprises one or a plurality of communication means wherein the communications means are configured to receive the first information item (e.g. to receive via one or a plurality of network connections of the internal network from an entity of the internal network).

For example, the first information item is received by the second server and/or the second server device. For example, the second server is configured to receive the first information item from an entity of the internal network and to send it to the first server. For example, the second server is configured to receive the first information item from an entity of the internal network and to send it to the first server without being requested (e.g. in the form of a push transfer). This is for example advantageous in order to ensure that the sending of the first information item to the second server is under the control of the entities of the internal network and cannot be controlled by (unauthorised) entities of the external network.

In the present case, information items are for example understood as information items that can be processed by a processor, such as data. An information item can for example be contained in one or a plurality of data containers such as one or a plurality of data packets and/or one or a plurality of files. For example, data can comprise digital information items and/or analogue information items.

Information items and/or data can for example be transferred (i.e. sent and/or received) by current signals, voltage signals, optical signals and/or radio signals.

For example, the first information item is contained in one or a plurality of data packets received by the first server and/or the first server device. For example, the first information item is contained in one or a plurality of files received by the first server and/or the first server device.

In the present case, an information item should be understood for example as originating from an entity when the information item was at least partially generated and/or recorded by the entity and/or a means of the entity.

For example, the first information item was at least partially generated and/or recorded by one or a plurality of entities of the internal network and/or a means of the entities of the internal network. For example, the first information item is the result of pre-processing performed by one or a plurality of entities of the internal network and/or a means of the entities of the internal network (e.g. pre-processing, encryption, authentication, etc.). For example, the pre-processing serves to ensure an optimal and/or secure transfer.

In the present case, an information item should be understood for example as based on another information item when the information item for example at least partially comprises the other information item and/or the information is at least partially the result of a summary and/or processing of the other information item.

The information item based on the first information item is for example at least partially the result of processing and/or integration of the first information item.

An information type of an information item is for example at least partially dependent on the location of generation and/or on the location of recording and/or the purpose of the information item. Examples of information types are control information items, environmental information items (e.g. traffic information items, weather information items and/or brightness information items) and/or status information items. A control information item such as a control instruction and/or a control parameter serves for example at least partially to control an entity (e.g. a device). An environmental information item serves for example at least partially to inform regarding one or a plurality of recordable properties of the environment at one or a plurality of locations (e.g. regarding the traffic, regarding the weather and/or regarding the brightness). A status information item serves for example to inform regarding the status of an entity (e.g. a device).

The first information item is for example an environmental information item (e.g. a traffic information item, a weather information item and/or a brightness information item) and/or a status information item.

A data container such as a data packet and/or a file which contains at least one part of an information item, can for example further contain a detail regarding the information type of the information item.

If the first information item is for example contained in one or a plurality of data packets, the data packets can for example further contain a detail regarding the information type of the first information item. If the first information item is for example contained in one or a plurality of files, the files can for example further contain a detail regarding the information type of the first information item (e.g. a corresponding ending of the file name). It is for example also conceivable for the first information item to contain a detail regarding the information type of the first information item.

In the present case, an information item should for example be understood as being obtainable by an entity if the information item can be obtained by the entity. For example, an information item is obtainbale by an entity if the information item can be received, read, recorded, retrieved and/or decrypted. If an information item is sent to an entity which is configured to receive the information item, the information item can for example be received by the entity, i.e. it can be obtained. If an information item is sent to an entity which is configured to receive the information item, the information item can for example be received by the entity, i.e. it can be obtained. If an information item is sent to an entity in response to a retrieval of the information item which is configured to receive the information item, the information item can for example be retrieved and received by the entity, i.e. it can be obtained by the entity.

Providing the first information item and/or the information item based on the first information item such that the first information item can be obtained only by the entities of the first group of entities of the external network, should in the present case for example be understood that the first information item can be received, read, recorded, retrieved and/or decrypted only by the entities of the first group of entities of the external network. For example, the first information item and/or the information item based on the first information item is provided by the first server such that the first information item can be received, read, recorded, retrieved and/or decrypted only by the entities of the first group of entities of the external network. For example, the first information item and/or the information item based on the first information item is sent only to the entities of the first group of entities (e.g. only sent encrypted to the entities of the first group of entities).

A group of entities of the external network for example comprises one or a plurality of entities of the external network. A group of entities of the internal network for example comprises one or a plurality of entities of the internal network.

For example, only the entities of a group of entities of the external network have the right to obtain information items of the information type allocated to the group of entities of the external network. A group of entities of the external network for example comprises all entities of the external network with the right to obtain information items of a certain information type. These rights for example predefine rules for providing information items of the respective information types. For example, rights information items regarding the rights of one or a plurality of groups of entities of the external network can be stored in a memory of the first server device.

For example, only the entities of the first group of entities of the external network have the right to obtain information items of the information type of the first information item and/or the information item based on the first information item.

By providing the first information item and/or the information item based on the first information item at least partially as a function of an allocation of an information type of the first information item and/or the information item based on the first information item to a first group of entities of the external network such that the first information item and/or the information item based on the first information item can be obtained only by the (authorised) entities of the first group of entities of the external network, according to the first aspect of the invention it can for example be ensured that the first information item and/or the information item based on the first information item can be obtained only by the entities of the first group of entities of the external network allocated to the information type of the first information item and/or the information item based on the first information item and not by entities of a group of entities of the external network different from the first group. This is for example advantageous in order to provide an interface between an internal network and an external network which enables the first information items to be selectively provided.

In the present case, causing and/or controlling a functional recovery and/or a functional update of one or a plurality of entities of a first group of entities of the internal network should for example be understood as a functional recovery information item and/or a functional update information item being provided to the one or the plurality of entities of the first group of entities of the internal network such that the one or plurality of entities of the first group of entities of the internal network are enabled to recover and/or update the function.

For example, each functional recovery information item and/or functional update information item provided for an entity of the one or plurality of entities of the first group of entities of the internal network is at least partially different from the further functional recovery information items and/or functional update information items provided for further entities of the one or plurality of entities of the first group of entities of the internal network. For example, a respective functional recovery information item (e.g. an individual functional recovery information item) and/or a respective functional update information item (e.g. an individual functional update information item) is respectively provided for each of the entities of the one or the plurality of entities of the first group of entities of the internal network.

For example, a corresponding functional recovery information item and/or a corresponding functional update information item is sent to the one or plurality of entities of the internal network (e.g. via one or a plurality of network connections of the internal network). For example, a corresponding functional recovery information item and/or a corresponding functional update information item is sent by the second server to the one or plurality of entities of the internal network (e.g. via one or a plurality of network connections of the internal network).

The one or plurality of entities of the first group of entities of the internal network are for example the entities of the first group of entities whose function(s) are supposed to be recovered and/or updated. For example, the one or plurality of entities of the first group of entities are the entities of the first group of entities whose functional recovery and/or functional update should be prompted and/or controlled (e.g. by the second server). The first group of entities of the internal network for example comprises the entities of the internal network whose functional recovery and/or functional update can be prompted and/or controlled (e.g. by the second server).

In the present case, updating a function of an entity should for example be understood as one or a plurality of functions of the entity being changed, for example by adding a function to the entity, deactivating a function of the entity and/or activating a function of the entity. In the present case, recovering a function of an entity should for example be understood as one or a plurality of functions of the entity being transferred in a defined state (e.g. the delivery state). For example, updating and/or recovering a function of an entity can comprise storing a program in a memory of the entity and/or changing a program stored in a memory of the entity. Such a program can for example be at least partially a driver program, an operating system program and/or an application program. For example, functions can be thereby (e.g. subsequently) added and/or removed. For example, the (software-based) support (e.g. a software-based plug & play support) can be thereby subsequently added to and/or removed from a component as a function such that the entities of the first group of entities of the internal network can be connected to such a component.

This is for example advantageous in order to enable remote-controlled administration of the function(s) of the entities of the first group of entities of the internal network (e.g. by the second server). On-site use can be avoided in many cases according to the second aspect of the invention for the functional recovery and/or functional update of the function(s) of the entities of the first group of entities of the internal network.

In the present case, a network should for example be understood as a device and/or an infrastructure for transmitting information items (e.g. data). Examples of a network are a wired network and/or a wireless network. An example of a wired network is an Ethernet. A further example of a wired network is a PoE network (PoE: Power over Ethernet, e.g. an IEEE 802.3af-2003 network or an IEEE 802.3at-2009 network) and a PLC network (PLC: Powerline Communication). A PoE network should for example also be understood as PoE+ network (POE+: Power over Ethernet Plus) and UPoE networks (UPoE: Universal Power over Ethernet). An example of a radio network is a mobile network such as a GSM network (GSM: Global System for Mobile Communications), a GPRS network (GPRS: General Packet Radio Service), a UMTS network (UMTS: Universal Mobile Telecommunications System), a LTE network (LTE: Long Term Evolution) an Advanced LTE network and a 5G mobile network. A further example of a wireless communication network is a wireless IEEE 802 network such as a WLAN network (WLAN: Wireless Local Area Network, an IEEE 802.11 network, e.g. an IEEE 802.11b network), a WiMAX network (WiMAX: Worldwide Interoperability for Microwave Access, an IEEE 802.16 network), a Bluetooth network (a IEEE 802.15.1 network), a Zigbee network (an IEEE 802.15.4 network) and a 6LoWPAN network (6LoWPAN: IPv6 over Low power Wireless Personal Area Network, e.g. an IEEE 802.15.4 network). A network is for example a network with a mesh topology. However, other network topologies are also conceivable (e.g. star topology and/or ring topology). A network can be composed of a plurality of different networks connected to each other (e.g. comprise one or a plurality of wired networks and/or one or a plurality of wireless networks). An example of a network which is composed of a plurality of different networks connected to each other is the internet.

Information can be transmitted via the network connections of a network according to one or a plurality of network protocols supported by the network. According to a packet-oriented network protocol, information is transmitted for example in data packets. Examples of network protocols are TCP/IP protocols (Transmission Control Protocol and Internet Protocol), UDP protocol (User Datagram Protocol) and IPX protocol (Internetwork Packet eXchange).

In the present case, entities of a network should for example be understood as devices which are configured to send and/or receive information via the network (e.g. to send and/or receive via one or a plurality of network connections of the network). The entities of a network are for example connected to each other via one or a plurality of network connections of the network. For example, the entities of a network can be connected to each other at least partially via one or a plurality of encrypted network connections of the network.

For example, the entities of the internal network are connected to each other via one or a plurality of network connections of the internal network (e.g. directly connected to each other). For example, the entities of the internal network are (e.g. directly) connected to the internal network. For example, the entities of the internal network are configured and/or comprise communication means which are configured to (e.g. directly) send and/or receive information via the internal network (e.g. to send and/or receive via one or a plurality of network connections of the internal network).

It is for example also conceivable for the entities of the internal network to be combined to form groups wherein such a group for example comprises a master entity and one or a plurality of slave entities. For example, only the master entity of such a group is (e.g. directly) connected to the internal network. For example, the entities of such a group are connected to each other via a local wireless network (e.g. a local wireless network different from the internal network). For example, the network connections are network connections protected via the local wireless network (e.g. VPN connections). For example, the slave entities of such a group are only indirectly connected to the internal network via the master entity of the group. For example, the slave entities of such a group can send and/or receive information via the internal network only directly via the master entity of the group.

For example, the master entities (e.g. the master entities of such a group) are configured and/or comprise communication means which are configured to (e.g. directly) send and/or receive information via the internal network (e.g. send and/or receive via one or a plurality network connections of the internal network) and (e.g. directly) send and/or receive information via the local wireless network (e.g. to send and/or receive via one or a plurality of network connections of the local wireless network). For example, the slave entities (e.g. the slave entities of such a group) are configured and/or comprise communication means which are configured to (e.g. directly) send and/or receive information (e.g. only) via the local wireless network (e.g. to send and/or receive via one or a plurality of network connections of the local wireless network).

For example, the entities of the external network are connected to each other (e.g. directly connected to each other) via one or a plurality of network connections of the external network. For example, the entities of the external network are configured and/or comprise communication means which are configured to (e.g. directly) send and/or receive information via the external network (e.g. to send and/or receive via one or a plurality of network connections of the external network).

The internal network and the external network are for example two different networks to each other. For example, the internal network and the external network are only indirectly and not directly connected to each other. Information can for example be exchanged via the first server (e.g. exclusively exchanged via the first server) between the entities of the internal network and the entities of the external network.

For example, the first server is at least partially formed as an information diode such that it provides a unidirectional interface for the transmission of information of the information type of the first information item from the internal network to the external network and such that it at least partially blocks the transmission of information from the external network to the internal network. In addition to this interface function, the first server can assume further functions such as for example a data analysis function. For example, the first server is an analytical server.

For example, the second server is an entity of the internal network. For example, the first server is connected only to the second server as an entity of the internal network. For example, the second server is directly connected to the first. For example, the further entities of the internal network are connected to the first server only via the second server. For example, the first information item is received by one or a plurality of entities of the internal network by the second server and sent by the second server to the first server and received there. This is for example advantageous in order to ensure that the transmission of information from the internal network by an entity of the internal network is controlled (e.g. by the second server of the internal network). In addition to this data forwarding function, the second server can assume further functions for the further entities of the internal network such as for example an administration function, a content management function, a remote control function and/or a remote maintenance function.

The internal network can for example comprise one or a plurality of entities which are connected (e.g. via PoE or PLC) in a wireless or wired manner (e.g. via PoE or PLC). For example, the internal network is at least partially the network of an infrastructure of an automation and/or control system (e.g. an industry 4.0 infrastructure). For example, the entities of the internal network and/or the internal network support cloud computing and/or edge computing and/or fog computing.

For example, the internal network is at least partially the network of a wireless infrastructure outdoors (e.g. a system for recording information outdoors and/or a lighting system). For example, the second server is a backend server and/or a backend server device of the wireless infrastructure.

For example, the internal server is the network of a system for recording information outdoors and the entities of the internal network comprise one or a plurality of devices with one or a plurality of means for recording information outdoors (e.g. sensors).

For example, the internal network is the network of a lighting system (e.g. a streetlighting system) and the entities of the internal network comprise one or a plurality of devices for controlling a light means (e.g. for controlling a light means of a street lamp). For example, the devices for controlling a light means further comprise one or a plurality of means for recording information outdoors. For example, the devices for controlling a light means can be at least partially remote-controlled and/or remotely-maintained (e.g. by the second server). Such a device for controlling a light means is for example described in the patent application with the reference DE 10 2014 102 678.0, to which reference is expressly made here. Such a device is further a device produced by the company ICE Gateway under the product name ICE Gateway.

For example, the external network is the internet and the entities of the external network comprise one or a plurality of internet-capable user devices such as smartphones, computers, notebook computers and/or tablet computers.

The present invention enables the transmission of information between two separate networks (e.g. two separate infrastructures) at least in the direction of the internal network to the external network. A unidirectional interface can thus for example be provided for the transmission of the information from the internal network to the external network. In this case, information of different information types can for example be transmitted respectively to different groups of entities of the external network. This is for example advantageous in order to prevent access to the internal network and to be able to limit access to the information to certain entities and/or groups of entities of the external network. The present invention thus enables a protected and selective exchange of information between two separate networks (e.g. an internal network of a system to record information outdoors and/or a lighting system and a public network. The present invention further enables the central administration of the function(s) of the entities of a first group of entities of the internal network. This is for example advantageous in order to at least partially enable remote-controlled administration of the function(s) of the entities of the first group of entities of the internal network and remote maintenance of these entities (e.g. by the second server).

Both the possibility to be able to transmit information from the internal network to the external network via an interface and also the (remote-controlled) administration of the function(s) of entities of the internal network can thus significantly simplify and improve the operation and the use of the internal network, i.e. the administration of the internal network. The devices and the methods according to the first, second and third aspect of the invention are thus for example respectively a device and a method for administering (e.g. for operating) the internal network.

The invention enables and/or supports for example so-called FoG computing. In this case, intelligent entities at both ends of an overall network (e.g. the internal and/or external network) handle for example (pre-)processing of information and/or data in multiple stages. The information and/or data are for example pre-processed in the internal network and in individual entities of the internal network before they are aggregated and analysed by the first and/or second server and/or in the external network.

Further advantages of the disclosed invention are described below on the basis of exemplary embodiments whose disclosure should apply equally to all the respective categories (method, device, system, computer program).

According to an exemplary embodiment of the first and third aspect of the invention, the first information item is provided by the server device such that the first information item is only obtainable by authenticated entities of the first group of entities of the external network.

In the present case, authenticating the entities of the first group of entities of the external network should for example be understood as a check being carried out for each of the entities of the first group of entities of the external network to determine whether the respective entity is one of the entities of the first group of entities of the external network. An entity of the first group of entities of the external network is for example authenticated after a positive check has been carried out to determine whether the entity is an entity of the first group of entities of the external network.

For example, the first information item is only obtainable by authenticated entities of the first group of entities of the external network when the access to the first information item and/or the retrieval of the first information item is protected. This can for example be achieved when the first information item is encrypted (e.g. encrypted such that it can be decrypted only by entities of the first group of entities of the external network) and/or when the first information item is stored in a protected storage area (e.g. in a password-protected storage area which can be accessed only by the entities of the first group of entities of the external network).

For example, the method according to the first and second aspect of the invention further comprises the authentication of the entities of the first group of entities of the external network (e.g. by the first server). For example, the means of the first server (e.g. the first server device) are configured to perform and/or control the authentication of the entities of the first group of entities of the external network.

For example, the authentication of the entities of the first group of entities of the external network comprises checking for each of the entities at least partially as a function of an authentication feature of the respective entity to determine whether the respective entity is one of the entities of the first group of entities of the external network. For example, the authentication of the entities of the first group of entities of the external network further comprises the receipt of an authentication feature from each of the entities of the first group of entities of the external network (e.g. via one or a plurality of network connections).

An authentication feature of an entity is for example a network address of the entity, a network address area, in which the network address of the entity is located, a password (e.g. a password input by a user to the entity), a biometric feature of a user of the entity (e.g. a biometric feature of a user of the entity recorded by the entity) and/or a cryptographic key (e.g. a public key and/or a secret key of an encryption process).

As described above, only the entities of the first group of entities of the external network for example have the right to obtain information of the information type of the first information item. For example, the authentication of the entities of the first group of entities of the external network comprises carrying out a check for each of the entities (e.g. at least partially as a function of an authentication feature) to determine whether the respective entity has the right to obtain information of the information type of the first information item.

According to an exemplary embodiment of the first and third aspect of the invention, different information types are respectively allocated at least partially to different groups of entities of the external network.

For example, different information types are respectively allocated to different groups of entities of the external network. These different allocations for example reflect the rights of the respective groups of entities of the external network to obtain information of a certain information type and/or for example predefine rules for the provision of information of the respective information types. For example, the first server is configured to provide a rules engine to provide an interface between an internal network and an external network and to selectively provide information at least partially as a function of the rules predefined by the allocations.

For example, an allocation information item regarding the allocation of the information type of the first information item and/or the information item based on the first information item to the first group of entities of the external network can be stored in a memory of the first server device. For example, further allocation information regarding the allocation of further information types (e.g. further information types different from the information type of the first information item) respectively to a group of entities of the external network (e.g. a group of entities of the external network different from the first group of entities of the external network) can be stored in the memory of the first server device. The allocation information for example predefine rules for the provision of information of the respective information types by the first server device. For example, the first server is configured to provide a rules engine to provide an interface between an internal network and an external network and to selectively provide information at least partially as a function of the rules predefined by the allocation information.

The affiliation of one entity to a group of entities and/or the right of one entity can for example be derived from a user of the entity (e.g. by the user inputting an authentication feature into the entity). This is for example advantageous in order to be able to provide different user groups with information of different information types (e.g. a user group can only obtain traffic information and a different user group can only obtain weather information).

According to an exemplary embodiment of the first and third aspect of the invention, the provision of the first information item and/or the information item based on the first information item comprises the storing of the first information item and/or the information item based on the first information item in a first storage area (e.g. by the first server) wherein the first storage area is allocated to the first group of entities of the external network. For example, the means of the first server (e.g. of the first server device) are configured to perform and/or control the storing of the first information item and/or the information item based on the first information item in a first storage area wherein the first storage area is allocated to the first group of entities of the external network. For example, the first storage area is a storage area of a memory of the first server device. However, it is also conceivable for the first storage area to be a storage area of a memory of a device different from the first server device.

For example, the first storage area is a database, a partition of a memory and/or a memory. For example, the first storage area is separated from other storage areas in terms of software and/or hardware.

For example, the information stored in the first storage area is only obtainable by the entities of the first group of entities of the external network. For example, the first storage area is protected such that access to the information stored in the first storage area and/or retrieval of the information stored in the first storage area is possible only by (e.g. authenticated) entities of the first group of entities of the external network. For example, the first storage area is password-protected. For example, the first storage area is encrypted.

For example, different storage areas are respectively allocated at least partially to different groups of entities of the external network. For example, the different storage areas are respectively separated from the other storage areas in terms of software and/or hardware. This is for example advantageous in order to enable a separation of the information of the different information types which are allocated to different groups of entities of the external network.

According to an exemplary embodiment of the first and third aspect of the invention, the provision of the first information item and/or the information item based on the first information item comprises the sending of the first information item and/or the information item based on the first information item (e.g. by the first server). For example, the means of the first server (e.g. the first server device) are configured to perform and/or control the sending of the first information item and/or the information item based on the first information item.

For example, the first information item and/or the information item based on the first information item is contained in one or a plurality of data packets (sent). For example, the first information item and/or the information item based on the first information item is contained in one or a plurality of files (sent). For example, the functional recovery information and/or the functional update information is part of a message (sent).

For example, the first information item and/or the information item based on the first information item is sent encrypted (e.g. via one or a plurality of encrypted network connections). For example, the first information item and/or the information item based on the first information item is sent encrypted (e.g. via one or a plurality of encrypted network connections) such that it can be received and decrypted only by the entities of the first group of entities. This is for example advantageous in order to protect the first information item and/or the information item based on the first information item during transmission and to ensure that the information cis only obtainable by entities of the first group of entities of the external network.

For example, the first information item and/or the information item based on the first information item is sent without being requested (e.g. sent in the form of a push transmission). For example, the first information item and/or the information item based on the first information item is sent by the first server without being requested (e.g. sent in the form of a push transmission). It is for example advantageous in order to ensure that the control over the sending is available to the first server and/or the first server device and cannot be controlled by (e.g. unauthorised) entities of the external network.

For example, the first information item and/or the information item based on the first information item is sent to one or a plurality of entities of the external network. For example, the first information item and/or the information item based on the first information item is sent by the server device to one or a plurality of entities of the external network.

For example, the first information item and/or the information item based on the first information item is sent by the first server and/or the first server device (e.g. only) to the entities of the first group of entities of the external network. For example, the first information item and/or the information item based on the first information item is sent by the first server and/or the first server device only to authenticated entities of the first group of entities of the external network (e.g. only to entities of the first group of entities of the external network which have been previously authenticated by the first server). This is for example advantageous in order to ensure that the information can be obtained only by entities of the first group of entities of the external network.

For example, the first information item and/or the information item based on the first information item is sent by the server device (e.g. only) to a server of the external network. For example, the server of the external network is configured to make available the first information item and/or the information item based on the first information item only to entities of the first group of entities and/or to ensure that the first information item and/or the information item based on the first information item is only obtainable by entities of the first group of entities.

For example, the server of the external network is configured to provide a network portal for accessing the first information item and/or the information item based on the first information item and/or to retrieving the first information item and/or the information item based on the first information item by the entities of the first group of entities of the external network. A network portal can for example be a website and/or a program interface such as an interface for SAP software (systems application products, SAP) which can be accessed via a network. A network portal can be a portal for remote control and/or remote maintenance of devices for controlling a light means (e.g. connected LED light means and/or LED lights). A network portal can, however, also be a portal for providing traffic data (e.g. traffic information) or a portal for providing marketing data (e.g. marketing information) for retail trade. A network portal can also be a portal for providing information recorded by local sensors such as CO2, ozone, precipitation and/or noise and/or similar. For example, the portals provide information as a basis for further decisions or processes which can lead to further events and conclusions.

For example, the server of the external network is configured to provide a network portal for authenticating the entities of the first group of entities of the external network and/or to access the first information item and/or the information item based on the first information item and/or to retrieve the first information item and/or the information item based on the first information item by the authenticated entities of the first group of entities of the external network. This is for example advantageous in order to ensure that the information can be obtained only by entities of the first group of entities of the external network.

According to an exemplary embodiment of the first and third aspect of the invention, the provision of the first information item and/or the information item based on the first information item comprises the integration of the first information item with at least one further information item (e.g. by the first server) and the provision of the integrated information (by the first server). In the present case, the integrated information should for example be understood as an information item based on the first information item.

For example, the means of the first server (e.g. the first server device) are configured to perform and/or control the integration of the first information item with at least one further information item and the provision of the integrated information.

In the present case, the integration of the first information item with a further information item should for example be understood as the first information item and the further information item being aggregated, analysed and/or evaluated. The aggregation, analysis and/or evaluation can for example take place by using an aggregation algorithm, an analysis algorithm and/or an evaluation algorithm on the first information item and the further information. An example of an evaluation algorithm is an algorithm for statistical evaluation (e.g. an algorithm for determining an average value and/or distribution of values). The integrated information for example comprises only the result of the integration such as the result of the aggregation of the information, the result of the analysis of the information and/or the result of the evaluation of the information.

For example, the first information item and the further information item are respectively one traffic information item of weather information. For example, the first information item and the further information item are analysed for recurring environmental situations in order to be able to provide a forecast for the future development of the environmental situation. For example, an analysis of traffic information can reveal that the probability for the future occurrence of a traffic jam is particularly high in the case of a certain traffic situation.

For example, the first information item and the further information item are respectively one status information item which informs regarding the status of an entity of the internal network. For example, the first information item and the further information item are evaluated to determine whether maintenance of the entity of the internal network is necessary (e.g. because the status of the entity of the internal network is deteriorating).

If the entity of the internal network is for example a device for controlling a light means, the status information can for example inform regarding the status of the light means. For example, the status information can comprise one current/average value for the supply voltage, the brightness and/or the supply current of the light means. A (e.g. statistical) change of this value can for example indicate necessary maintenance of the light means. In this case, an information item can for example be provided (e.g. as an information item based on the first information item) indicating that maintenance of the light means is necessary.

For example, the first information item is an information item of a Bluetooth device (e.g. a Bluetooth ID) recorded by a radiation sensor for Bluetooth signals. This information item can for example be evaluated together with further information items recorded by the radiation sensor in order to perform traffic counting for the location of the radiation sensor (e.g. counting cars). For example, all information items of a Bluetooth device recorded in a certain time period by the radiation sensor for Bluetooth signals, which originate from different Bluetooth devices, are counted. In this case, a traffic information item can for example be provided (e.g. as information based on the first information item) which comprises the result of the count. Alternatively or additionally, it is also conceivable for the information of a Bluetooth device recorded in this example by the radiation sensor for Bluetooth signals (e.g. a Bluetooth ID) to be integrated with an information item recorded by a sound sensor in order to recognise not only the device, but also whether it is a pedestrian, bicycle, a car and/or a different vehicle and/or in which direction the device is moving. For example, all cars passing the location of the radiation sensor/sound sensor (e.g. all cars travelling in a certain direction) can be counted. In this case, a traffic information item can for example be provided (e.g. as the information item based on the first information item) which comprises the result of the counting of the car passing by the location of the radiation sensor/sound sensor).

This is for example advantageous in order to relieve the entities of the external network and enable a central integration (e.g. aggregation and/or evaluation) of the information such that the entities of the external network obtain the integrated information and do not have to first integrate the information. This is for example advantageous if the information would otherwise be integrated by a plurality of entities of the external network.

According to an exemplary embodiment of the first and third aspect of the invention, the provision of the first information item and/or the information item based on the first information item comprises the processing of the first information item (e.g. by the first server) and the provision of the processed information (by the first server). In the present case, the processed information should for example be understood as an information item based on the first information item.

For example, the means of the first server (e.g. the first server device) are configured to perform and/or control the processing of the first information item and the provision of the processed information.

In the present case, processing of the first information item should for example be understood as organising, analysing and/or changing the first information item. Organising, analysing and/or changing the first information item can for example take place by using a data processing algorithm on the first information item. An example of a data processing algorithm is an evaluation algorithm and/or an analysis algorithm. The processed information item for example comprises only the result of the organisation, analysis and/or the changing of the first information item.

For example, the first information item is a status information item which informs regarding the status of an entity of the internal network. For example, the first information item is evaluated to determine whether maintenance of the entity of the internal network is necessary (e.g. because the status of the entity of the internal network is outside of a predefined status). If the entity of the internal network is for example a device for controlling a light means, the status information can for example inform regarding the status of the light means. For example, the status information can comprise one instantaneous/average value for the supply voltage, the brightness and/or the supply current of the light means. If this value is above or below a limit value, maintenance of the light means may for example be necessary. In this case, an information item can for example be provided (e.g. as the information item based on the first information item) which indicates that maintenance of the lighting means is necessary.

This is for example advantageous in order to relieve the entities of the external network and enable a central processing of the first information item such that the entities of the external network obtain the processed information and do not have to first process the information. This is for example advantageous if the first information item would otherwise be processed by a plurality of entities of the external network.

According to an exemplary embodiment of the method according to the first and third aspect of the invention, the method further comprises the receipt of a second information item (e.g. by the first server) wherein the second information item originates from an entity of a second group of entities of the external network and the provision of the second information item and/or an information item based on the second information item (e.g. by the first server) such that the second information item is only obtainable by one or a plurality of entities of the internal network.

For example, the means of the first server (e.g. the first server device) are configured to perform and/or control the receipt of a second information item wherein the second information item originates from an entity of a second group of entities of the external network and the provision of the second information item and/or the information item based on the second information item such that the second information item and/or the information item based on the second information item is only obtainable by one or a plurality of entities of the internal network.

For example, the second information item is received by the first server. For example, the second information item is received via one or a plurality of network connections of the external network. For example, the second information item is received encrypted (e.g. via one or a plurality of encrypted network connections). For example, the first server device comprises one or a plurality of communication means wherein the communication means are configured to receive the second information item (e.g. to receive via one or a plurality of network connections of the external network).

For example, the second information item is contained in one or a plurality of data packets received by the server device. For example, the second information item is contained in one or a plurality of files received by the server device.

As described above, in the present case, an information item should for example be understood as originating from an entity if the information item was at least partially generated and/or recorded by the entity and/or a means of the entity.

For example, the second information item was at least partially generated and/or recorded by the entity of the second group of entities of the external network and/or a means of the entity of the second group of entities of the external network.

For example, the second information item is received by the entity of the second group of entities of the external network, which and/or whose means have at least partially generated and/or recorded the second information item. For example, the second information item is received by the first server from the entity of the second group of entities of the external network, which and/or whose means have at least partially generated and/or recorded the second information item.

For example, the second information item is sent to a server of the external network by the entity of the second group of entities of the external network, the and/or whose means have at least partially generated and/or recorded the second information item. For example, the second information item is received by the server of the external network. For example, the second information item is received by the first server from the server of the external network. For example, the server of the external network is configured to provide a network portal to receive second information items from the entities of the second group of entities of the external network. A network portal can for example be a website and/or a program interface such as an interface for SAP software (systems applications products, SAP) which can be accessed via a network. A portal can be a portal for remote control and/or for remote maintenance of devices for controlling a light means (e.g. connected LED light means and/or LED lights). A portal can, however, also be a portal for providing traffic data (e.g. traffic information) or a portal for providing marketing data (e.g. marketing information) for retail trade. A portal can also be a portal for providing information recorded by local sensors such as CO2, ozone, precipitation and/or noise and/or similar. For example, the portals provide information as a basis for further decisions or processes which can lead to further events and conclusions.

For example, the server of the external network is configured to provide a network portal for authenticating the entities of the second group of entities of the external network and/or for receiving the second information item by the authenticated entities of the second group of entities of the external network. This is for example advantageous in order to ensure that the second information item originates only from entities of the second group of entities of the external network.

The information item based on the second information item is for example at least partially the result of processing and/or integration of the second information item.

By way of the provision of the second information item and/or the information item based on the second information item by the server device such that the second information item or the information item based on the second information item is only obtainable by one or a plurality of entities of the internal network, it can for example be ensured that the second information item and/or the information item based on the second information item is only obtainable by the entities of the internal network and not by entities of the external network.

As described above, in the present case, an information item should for example be understood as obtainable by an entity when the information can be obtained by the entity.

For example, the second information item and/or the information item based on the second information item is provided such that the second information item and/or the information item based on the second information item can be received, read, recorded, retrieved and/or decrypted only by one or a plurality of entities of the internal network. For example, the second information item and/or the information item based on the second information item is sent only to one or a plurality of entities of the internal network (e.g. only sent encrypted to the entities of the internal network).

As described above, the first server device is at least partially formed as an information diode such that it provides a unidirectional interface for the transmission of information of the information type of the first information item from the internal network to the external network and such that it at least partially blocks the transmission of information from the external network to the internal network. For example, the first server device is at least partially formed such that it further provides a unidirectional interface for the transmission of information, which originates from the second group of entities of the external network, from the external network to the internal network and such that it at least partially blocks the transmission of other information from the external network to the internal network.

For example, the second information item and/or the information item based on the second information item is sent by the first server and/or the first server device to the second server and/or the second server device and is received there and sent by the second server to one or a plurality of further entities of the internal network (e.g. sent encrypted). This is for example advantageous in order to ensure that the transmission of information from the internal network is controlled by an entity of the internal network (e.g. by the second server).

This is for example advantageous in order to enable the transmission of information between two separate networks also in the direction from the external network to the internal network. In this case, information, which originates from the second group of entities of the external network, is for example transmitted to the entities of the internal network. A unidirectional interface for the transmission of information, which originates from the second group of entities of the external network, can thus for example be provided from the external network to the internal network. This is for example advantageous in order to prevent indirect access to the internal network and to be able to limit the communication with the entities of the internal network to the second group of entities of the external network. The present invention thus enables a protected and selective exchange of information between two separate networks.

According to an exemplary embodiment of the first and third aspect of the invention, the second information item and/or the information item based on the second information item is only then provided when the second information item originates from an entity of the second group of entities of the external network.

For example, only the entities of the second group of entities of the external network have the right to transmit information to one or a plurality of entities of the internal network (e.g. to transmit via the first server).

For example, rights information regarding the rights of one or a plurality of groups of entities of the external network can be stored in a memory of the first server device. This rights information predefines for example rules for the provision of the second information item by the first server device. For example, the first server is configured to provide a rules engine to provide an interface between an internal network and an external network and to selectively provide information at least partially as a function of the rules predefined by the right information.

For example, the second information item and/or the information item based on the second information item is then only provided when the second information item is received by an entity of the second group of entities of the external network and/or via a protected network connection. A protected network connection is for example a network connection via which information is transmitted encrypted. An example of a protected network connection is a network connection of a VPN network and/or a network connection according to the https protocol (Hypertext Transfer Protocol Secure, https).

According to an exemplary embodiment of the first and third aspect of the invention, the second information item and/or the information item based on the second information item is then only provided when the second information item originates from an authenticated entity of the second group of entities of the external network (e.g. is received). For example, the second information item and/or the information item based on the second information item is then only provided by the first server device when the second information item from an authenticated entity of the second group of entities of the external network is received by the server device and/or received by the server device via a protected network connection.

In the present case, authentication of an entity of the second group of entities of the external network should for example be understood as a check being carried out for the entity of the second group of entities to determine whether the entity is one of the entities of the second group of entities of the external network. An entity of the second group of entities of the external network is for example authenticated after a positive check has been carried out to determine whether the entity is an entity of the second group of entities.

For example, the method according to the first and the third aspect of the invention further comprises the authentication of the entity of the second group of entities of the external network (e.g. by the first server). For example, the means of the first server (e.g. the first server device) are configured to perform and/or control the authentication of the entity of the second group of entities of the external network.

As described above, in the present case authentication of an entity of the second group of entities of the external network should be understood as a check being carried out for the entity of the second group of entities to determine whether the entity is an entity of the second group of entities of the external network. For example, the authentication of the entity of the second group of entities comprises checking for the entity at least partially as a function of an authentication feature of the entity to determine whether the entity is one of the entities of the second group of entities. For example, the authentication of the entity of the second group of entities of the external network further comprises the receipt of an authentication feature from the entity (e.g. via one or a plurality of network connections).

As described above, only the entities of the second group of entities of the external network for example have the right to transmit information to one or a plurality of entities of the internal network. For example, the authentication of the entities of the first group of entities comprises checking for each of the entities (e.g. at least partially as a function of an authentication feature) whether the respective entity has the right to transmit information to one or a plurality of entities of the internal network.

According to an exemplary embodiment of the method according to the first and third aspect of the invention, the method further comprises checking the second information item and/or checking the information item based on the second information item (e.g. by the first server). For example, the means of the first server (e.g. the first server device) are configured to perform and/or control the checking of the second information item and/or the checking of the information item based on the second information item.

For example, a check is carried out at least partially as a function of provisioning rule information to determine whether the second information item and/or the information item based on the second information item may be provided such that the second information item is only obtainable by one or a plurality of entities of the internal network. For example, the second information item and/or the information item based on the second information item is then only provided when the check, at least partially as a function of provisioning rule information, results in the second information item and/or the information item based on the second information item being allowed to be provided such that the second information item is only obtainable by one or a plurality of entities of the internal network.

For example, corresponding provisioning rule information is stored in a memory of the first server (e.g. the first server device).

For example, the provisioning rule information predefines that the second information item and/or the information item based on the second information item may only be provided when the second information item originates from an entity of the second group of entities of the external network (e.g. is received) and/or if the second entity originates from an authenticated entity of the second group of entities of the external network (e.g. is received).

For example, the provisioning rule information predefines that the second information item and/or the information item based on the second information item may only be provided when the second information item is received in a predefined time period.

For example, the provisioning rule information predefines that the second information item and/or the information item based on the second information item may only be provided when it comprises one or a plurality of predefined instructions and/or parameters and that the second information item and/or the information item based on the second information item may not be provided when it comprises instructions and/or parameters deviating therefrom.

For example, the provisioning rule information predefines that the second information item and/or the information item based on the second information item may only be provided when it comprises no more than a predefined number of instructions and/or parameters.

The checking is for example advantageous in order to prevent the second information item and/or the information item based on the second information item being provided improperly.

According to an exemplary embodiment of the first and third aspect of the invention, the provision of the second information item and/or the information item based on the second information item comprises the storing of the second information item and/or the information item based on the second information item in a second storage area (e.g. by the first server) wherein the second storage area is allocated to the entities of the internal network. For example, the means of the first server (e.g. of the first server device) are configured to perform and/or control the storing of the second information item and/or the information item based on the second information item in a second storage area wherein the second storage area is allocated to the entities of the internal network. For example, the second storage area is a storage area of a memory of the first server device. However, it is also conceivable for the second storage area to be a storage area of a memory of a device that is different from the first server device.

For example, the information stored in the second storage area is only obtainable by the entities of the internal network. For example, the second storage area is protected such that access to the information stored in the second storage area and/or retrieval of the information stored in the second storage area is possible only by entities of the internal network. For example, the second storage area is password-protected. For example, the second storage area is encrypted.

This is for example advantageous in order to enable a separation of the second information item and/or the information items based on the second information item from other information items such as for example the first information item.

According to an exemplary embodiment of the first and third aspect of the invention, the provision of the second information item and/or the information item based on the second information item comprises the sending of the second information item and/or the information item based on the second information item to one or a plurality of entities of the internal network (e.g. by the first server). For example, the means of the first server (e.g. the first server device) are configured to perform and/or control the sending of the second information item and/or the information item based on the second information item to one or a plurality of entities of the internal network.

For example, the second information item and/or the information item based on the second information item is contained in one or a plurality of data packets (sent). For example, the second information item and/or the information item based on the second information item is contained in one or a plurality of files (sent). For example, the functional recovery information and/or the functional update information is part of a message (sent).

For example, the second information item and/or the information item based on the second information item is sent encrypted to one or a plurality of entities of the internal network (e.g. via one or a plurality of encrypted network connections). This is for example advantageous in order to protect the second information item during the transmission.

For example, the sending of the second information item and/or the information item based on the second information item is initiated by one or a plurality of entities of the internal network (e.g. by the second server). For example, the second information item or the information based on the second information item is retrieved by one or a plurality of entities of the internal network (e.g. by the second server). This is for example advantageous in order to ensure that the control over the sending of the second information item and/or the information item based on the second information item is available to the entities of the internal network (e.g. the second server and/or the second server device) and cannot be controlled by (e.g. unauthorised) entities of the external network.

For example, the second information item and/or the information item based on the second information item is sent to the second server. For example, the second server is configured to make available the second information item and/or the information item based on the second information item only to entities of the internal network and to ensure that the second information item or the information item based on the second information item is obtainable only by entities of the internal network.

According to an exemplary embodiment of the first and third aspect of the invention, the provision of the second information item and/or the information item based on the second information item comprises the integration of the second information item with at least one further information item and the provision of the integrated information (e.g. by the first server). In the present case, the integrated information should for example be understood as an information item based on the second information item.

For example, the means of the first server (e.g. the first server device) are configured to perform and/or control the integration of the second information item with at least one further information item and the provision of the integrated information.

In the present case, the integration of the second information item with a further information item should for example be understood as the second information item and the further information item being aggregated, analysed and/or evaluated. The aggregation, analysis and/or evaluation can for example take place by using an aggregation algorithm, an analysis algorithm and/or an evaluation algorithm on the second information item and the further information item. An example of an evaluation algorithm is an algorithm for statistical evaluation (e.g. an algorithm for determining an average value and/or distribution of values). The integrated information for example comprises only the result of the integration such as the result of the aggregation of the information, the result of the analysis of the information and/or the result of the evaluation of the information.

This is for example advantageous in order to relieve the entities of the internal network and enable a central integration (e.g. Aggregation, analysis and/or evaluation) of the information such that the entities of the internal network obtain the integrated information and do not have to first integrate the information. This is for example advantageous if the information would otherwise be integrated by a plurality of entities of the internal network.

According to an exemplary embodiment of the first and third aspect of the invention, the provision of the second information item and/or the information item based on the second information item comprises the processing of the second information item and the provision of the processed information (e.g. by the first server).

For example, the means of the first server (e.g. the first server device) are configured to perform and/or control the processing of the second information item and the provision of the processed information.

In the present case, processing the second information item should for example be understood as organising and/or changing the second information item. The organising and/or changing of the second information item can for example take place by using a data processing algorithm on the second information item. An example of a data processing algorithm is an analysis algorithm and/or an evaluation algorithm. The processed information for example comprises only the result of the organising and/or changing of the second information item.

This is for example advantageous in order to relieve the entities of the internal network and enable a central processing of the second information item such that the entities of the internal network obtain the processed information and do not have to first process the information. This is in particular advantageous if the second information item would otherwise be processed by a plurality of entities of the internal network.

According to an exemplary embodiment of the first and third aspect of the invention, the entities of the first group of entities of the external network are at least partially different (e.g. completely different) from the entities of the second group of entities of the external network. However, it is also conceivable for the entities of the first groups of entities of the external network and the entities of the second groups of entities of the external network to be at least partially identical (e.g. completely identical).

According to an exemplary embodiment of the first and third aspect of the invention, the second information item and/or the information item based on the second information item comprises a control information item such as a control instruction and/or a control parameter for controlling one or a plurality of entities of the internal network.

Control instructions are for example instructions to a device for controlling a light means which cause the device to switch on, switch off and/or dim the light means. Control parameters are for example a switching-on time, a switching-off time, a dimming value, a brightness threshold value for switching on/off, a supply voltage value and/or a supply current value. For example, a control information item comprises one or a plurality of firing charts.

A firing chart is based for example at least partially on a defined calendar for a location (such as for example solar calendar, civil calendar, nautical calendar and/or similar) which defines the time of the sunset and/or sunrise at the location. This calendar can for example be adapted as desired by an editor of a user. A light intensity per unit of time is then for example allocated. The requirement for additional light can thus be combined with the real requirement at each time and at each location. A firing chart can thus cause light of the light means to start for example initially with 50% and later increase to 100% and then fall back to 30% after a few hours. The start and end times can be changed for example by a few minutes.

According to an exemplary embodiment of the first and third aspect of the invention, the first information item and/or the information item based on the first information item comprise an environmental information item and/or a status information item.

For example, the first information item is an environmental information item recorded and/or created by a means of an entity of the internal network and/or by an entity of the internal network. For example, one or a plurality of entities of the internal network comprise one or a plurality of sensors wherein the sensors are configured to record and/or create an environmental information item. A sensor should for example be understood as a device (e.g. a video camera) and/or a technical element (e.g. a CCD sensor and/or a CMOS sensor), in particular an electric or electronic technical element which is configured to be able to record certain physical or chemical properties (e.g.: radiation, temperature, moisture, pressure, sound, brightness or acceleration) and/or the material quality of its surroundings qualitatively or quantitatively as a measured value. These variables are for example recorded by means of physical or chemical effects and converted into an environmental information item (e.g. converted into a further processable electric signal).

A sensor can for example be connected in a wired and/or wireless manner to an entity of the internal network. For example, the entities of the internal network are configured and/or comprise communication means which are configured to be connected to one or a plurality of sensors and to receive information from the sensors and/or send information to the sensors. For example, a sensor can be connected to a network interface, a data interface and/or an analogue/digital converter of an entity of the internal network. An example of a network interface and/or a data interface is a USB interface, an IEEE 1394 interface, a CAN-Bus interface, a Zigbee interface, a Bluetooth interface, a serial interface such as a R232 interface and/or a parallel interface such as an IEEE 1284 interface. For example, the entities of the internal network are configured for a software-based plug & play support of the sensors (e.g. on the basis of a corresponding functional update). It is also conceivable for a sensor to be part of a mobile device such as a mobile phone wherein the mobile device is connected to an entity of the internal network in a wired and/or wireless manner and/or the mobile device is an entity of the internal network.

Examples of a sensor are a temperature sensor (e.g. a thermometer, thermoelement and/or a thermoresistor), an environmental temperature sensor, a brightness sensor, a motion sensor (e.g. a motion detector), an acoustic sensor, an ultrasound sensor, radiation sensor (e.g. for WLAN signals and/or Bluetooth signals), a sound sensor (e.g. a microphone), an optical sensor, an infrared sensor, a light sensor (e.g. a photo diode and/or a photo resistor), an image sensor (e.g. an imaging camera, a CMOS sensor and/or a CCD sensor), a video sensor (e.g. a video camera, a CMOS sensor and/or a CCD sensor), a current sensor, a voltage sensor, a power sensor, a chemical sensor (e.g. a gas sensor), an explosives detection sensor, a precipitation sensor and/or a vibration sensor.

For example, the first information item is an information item of a Bluetooth device recorded by a radiation sensor for Bluetooth signals (e.g. a Bluetooth ID) which for example can be recorded, integrated and/or processed for the counting of cars in traffic and/or can serve as a basis for marketing information (e.g. for location-related advertising on smartphones).

For example, the first information item is a status information item recorded and/or created by a means of an entity of the internal network and/or by an entity of the internal network. A status information item is for example an information item regarding the status of a device for controlling a light means such as for example an information item regarding one or a plurality of control events (e.g. switching on, switching off, energy consumption, supply voltage value and/or supply current value of the light means) and/or regarding one or a plurality of error events (e.g. power failure, failure of the light means).

According to an exemplary embodiment of the third aspect of the invention, the causing and/or control of the functional update of one or a plurality of entities of the first group of entities of the internal network takes place at least partially as a function of a second information item originating from an entity of the second group of entities of the external network. For example, the causing and/or control of the functional update of one or a plurality of entities of the first group of entities of the internal network takes place at least partially in response to the receipt of the second information item.

For example, the second information item is a control information item for the one or plurality of entities of the first group of entities of the internal network. For example, an update and/or recovery of the function of the one or plurality of entities of the first group of entities of the internal network is controlled and/or prompted corresponding to the control information item. When the control information item for example comprises a control parameter for the one or plurality of entities of the first group of entities of the internal network, a corresponding recovery and/or update of the control parameter of the one or plurality of entities of the first group of entities of the internal network is for example controlled and/or prompted.

For example, the second information item is a control information item which is sent from the first server and/or the first server device to the second server and/or the second server device and received there. For example, an update and/or recovery of the function of the one or plurality of entities of the first group of entities of the internal network is controlled and/or prompted corresponding to the control information item.

According to an exemplary embodiment of the method according to the second and third aspect of the invention, the method further comprises the sending of a functional monitoring information item to each entity of the first group of entities of the internal network (e.g. by the second server) and the receipt of one or a plurality of functional recovery request information items from the one or plurality of entities of the first group of entities of the internal network (e.g. by the second server) wherein the causing and/or control of the functional recovery of the one or plurality of entities of the first group of entities of the internal network takes place at least partially as a function of the received functional recovery request information items.

For example, the means of the second server (e.g. the second server device) are configured to cause and/or control the sending of a respective functional monitoring information item to each entity of the first group of entities of the internal network and the receipt of one or a plurality of functional recovery request information items from the one or plurality of entities of the first group of entities of the internal network wherein the causing and/or control of the functional recovery of the one or plurality of entities of the first group of entities of the internal network takes place at least partially as a function of the received functional recovery request information items.

In the present case, a functional monitoring information item should for example be understood as each information item which is suitable for functional monitoring of an entity of the first group of entities of the internal network (e.g. is suitable to interact with a watchdog functionality of the entity of the first group of entities of the internal network). For example, the format of the functional monitoring information is predefined.

For example, the functional monitoring information is contained in one or a plurality of data packets. For example, the functional monitoring information is contained in one or a plurality of files. For example, the functional monitoring information is part of a message e.g. of a keepalive message.

For example, the functional monitoring information is at least partially the same for each entity of the first group of entities of the internal network. However, it is also conceivable for the functional monitoring information to be at least partially different for each entity of the first group of entities of the internal network.

In the present case, a functional recovery request information item should for example be understood as any information item that is suitable for at least partially triggering the causing and/control of the functional recovery of the one or plurality of entities of the first group of entities of the internal network. For example, the format of the functional recovery request information item is predefined.

For example, each of the functional recovery request information items is contained in one or a plurality of data packets. For example, each of the functional recovery request information items is contained in one or a plurality of files. For example, each of the functional recovery request information items is part of a message e.g. a recovery message.

For example, each of the functional recovery request information items is generated and sent by respectively one of the one or plurality of entities of the first group of entities. For example, each functional recovery request information item contains information regarding the function(s) to be recovered of the respective entity of the one or plurality of entities of the first group of entities. For example, a functional recovery request information item contains information regarding the software (e.g. the revision status of an operating system and/or a program) and/or regarding the hardware (e.g. processor type and/or storage capacity) of the respective entity.

For example, the entities of the first group of entities of the internal network respectively have one watchdog functionality. For example, the watchdog functionality monitors for the respective entity to determine whether a functional monitoring information item is received (e.g. in a certain time period) by the respective entity. If functional monitoring information (e.g. in a certain time period) is not received by the respective entity, the watchdog functionality is prompted and/or controlled for example such that a functional recovery request information item is generated and sent from the respective entity (e.g. is sent to the second server).

For example, the watchdog functionality comprises the causing (e.g. upon suspecting a malfunction or manipulation of the respective device for controlling a light means) of the transfer of the respective entity into a functioning and/or safe state. For example, the watchdog functionality can cause the respective entity and/or a partial system of this respective entity to switch off and be transferred into a functioning and/or safe state. For example, the watchdog functionality can cause a primary operating system of the respective entity to be replaced by a secondary operating system (e.g. a minimal, guaranteed functioning and normally inactive emergency operating system). For example, a memory of a processor of the respective entity, which contains the primary operating system, could be transparently (e.g. according to the principle of a double buffer) replaced by another memory of the processor of the respective entity which contains the secondary operating system. The secondary operating system could then be started (e.g. by a booting process of the entity e.g. the watchdog function can comprise the causing of the booting process) and from this functioning and/or safe state a functional recovery request information item can be generated and sent by the respective entity (e.g. is sent to the second server).

For example, the causing and/or control of the functional recovery of the one or plurality of entities of the first group of entities of the internal network takes place at least partially in response to the received functional recovery request information items. For example, the receipt of the one or plurality of functional recovery request information items (e.g. by the second server) triggers the causing and/or control of the functional recovery of the one or plurality of entities of the first group of entities of the internal network. This is for example advantageous in order to enable central administration and recovery of the functions of the entities of the first group of entities of the internal network.

According to an exemplary embodiment of the second and/or third aspect of the invention, a functional monitoring information item is repeatedly sent to each entity of the first group of entities of the internal network. For example, a functional monitoring information item is sent at regular and/or irregular intervals to each entity of the first group of entities of the internal network. For example, the sent functional monitoring information items are at least partially different from each other. However, it is also conceivable for the sent functional monitoring information items to be at least partially the same.

According to an exemplary embodiment of the second and/or third aspect of the invention, the causing and/or control of the functional recovery and/or the functional update of the one or plurality of entities of the first group of entities of the internal network comprises the sending of a functional recovery information item and/or a functional update information item (e.g. a respective functional recovery information item and/or a respective functional update information item) to each of the one or plurality of entities of the first group of entities of the internal network (e.g. by the second server). For example, the means of the second server (e.g. the second server device) are configured to perform and/or control the sending of the functional recovery information item and/or the functional update information item to each of the one or plurality of entities of the first group of entities of the internal network.

For example, each of the functional recovery information item and/or the functional update information item sent to an entity of the one or plurality of entities of the first group of entities of the internal network is at least partially different from the further recovery information items and/or the functional update information items sent to the further entities of the one or plurality of entities of the first group of entities of the internal network. For example, a respective functional recovery information item (e.g. an individual functional recovery information item) and/or a respective functional update information item (e.g. an individual functional update information item) is respectively sent to each entity of the one or plurality of entities of the first group of entities of the internal network.

The one or plurality of entities of the first group of entities are for example the entities of the first group of entities whose function(s) should be recovered and/or updated. For example, the one or plurality of entities of the first group of entities are the entities of the first group of entities whose functional recovery and/or functional update should be prompted (e.g. by the second server). For example, a functional recovery information item (e.g. a respective functional recovery information item) is sent to each of the one or plurality of entities of the first group of entities of the internal network from which a functional recovery request information item was received.

For example, the functional recovery information item and/or functional update information item is contained in one or a plurality of (sent) data packets. For example, the functional recovery information item and/or functional update information item is contained in one or a plurality of (sent) files. For example, the functional recovery information and/or the functional update information is part of a message (sent).

For example, the functional recovery information item and/or functional update information item is sent via one or a plurality of network connections of the internal network.

According to an exemplary embodiment of the second and/or third aspect of the invention, the respective functional recovery information item comprises a respective functional recovery program and/or the respective functional update information item comprises a respective functional update program.

For example, the functional recovery information item and/or the functional update information item for each of the one or plurality of entities of the first group of entities of the internal network respectively comprises one functional recovery program and/or one functional update program.

For example, each of the functional recovery information item and/or the functional update information item sent to an entity of the one or plurality of entities of the first group of entities of the internal network is at least partially different from the further recovery information items and/or the functional update information items sent to the further entities of the one or plurality of entities of the first group of entities of the internal network. For example, each of the functional recovery information items and/or the functional update information items sent to a respective entity of the one or plurality of entities of the first group of entities of the internal group comprises a respective functional recovery program and/or a respective functional update program (e.g. a functional recovery program and/or a functional update program for the respective entity of the one or plurality of entities of the first group of entities of the internal network).

For example, the functional recovery program and/or a functional update program for each of the one or plurality of entities of the first group of entities of the internal network is at least partially different. However, it is also conceivable for the functional recovery program and/or the functional update program for each of the one or plurality of entities of the first group of entities of the internal network to be at least partially identical.

A functional recovery program for example comprises program instructions which cause an entity of the first group of entities of the internal network (e.g. a device) to recover one or a plurality of functions of the entity (e.g. cause to store a program in a memory of the entity and/or to change a program stored in a memory of the entity) when the functional recovery program is executed by one or a plurality of processors of the entity. For example, the respective functional recovery program comprises program instructions which cause the respective entity of the first group of entities of the internal network to perform the functional recovery when the functional update program is executed by one or a plurality of processors of this respective entity.

A functional update program for example comprises program instructions which cause an entity of the first group of entities of the internal network (e.g. a device) to update one or a plurality of functions of the entity (e.g. cause to store a program in a memory of the entity and/or to change a program stored in a memory of the entity) when the functional recovery program is executed by one or a plurality of processors of the entity. For example, the respective functional update program comprises program instructions which cause the respective entity of the first group of entities of the internal network to perform the functional update when the functional update program is executed by one or a plurality of processors of this respective entity.

For example, functions of a plurality of entities of the internal network can also be linked to each other by such a functional update program. For example, an environmental information item recorded by a sensor connected to a first entity of the internal network can influence (e.g. control) a function of a second entity of the internal network (e.g. a control of a light means). For example, a corresponding functional update of the first entity of the internal network can be prompted by a first functional update program and a corresponding functional update of the second entity of the internal network can be prompted by a second functional update program.

An example of a functional recovery program and/or a functional update program is an installation program and/or an update program.

According to an exemplary embodiment of the second and/or third aspect of the invention, the functional recovery information item for each of the one or plurality of entities of the first group of entities of the internal network respectively comprises a functional recovery time and/or a functional recovery time period.

For example, the functional recovery time predefines a time at which the entity which receives the functional recovery information item begins and/or concludes the functional recovery (e.g. the time at which the recovered function(s) is/are activated). For example, the functional recovery time period predefines a time period in which the entity which receives the functional recovery information item begins and/or concludes the functional recovery (e.g. the time period in which the recovered function(s) is/are activated). This is for example advantageous in order to be able to centrally control and/or administer the time/time period of the functional recovery. All entities can thus for example be prevented from simultaneously activating the recovered function(s).

For example, the functional recovery time and/or a functional update time period for each of the one or plurality of entities of the first group of entities of the internal network is at least partially different. For example, the functional recovery information item provided for the one or plurality of entities of the first group of entities of the internal network respectively differ from each other at least partially by the functional recovery time and/or the functional recovery time period.

This is for example advantageous when the one or plurality of entities of the first group of entities of the internal network are devices for controlling a light means in order to prevent the light means from all being activated simultaneously (which e.g. could lead to a breakdown of the power supply network of the light means and/or the lighting network).

According to an exemplary embodiment of the second and/or third aspect of the invention, the functional update information item for each of the one or plurality of entities of the first group of entities of the internal network respectively comprises a functional update time and/or a functional update time period.

For example, the functional update time predefines a time at which the entity which receives the functional update information begins and/or concludes the functional update (e.g. the time at which the updated function(s) is/are activated). For example, the functional update time period predefines a time period in which the entity which receives the functional update information item begins and/or concludes the functional update (e.g. the time period in which the updated function(s) is/are activated). This is for example advantageous in order to be able to centrally control and/or administer the time/time period of the functional update. All entities can thus for example be prevented from simultaneously activating the updated function(s).

For example, the functional update time and/or the functional update time period is at least partially different for each of the one or plurality of entities of the first group of entities of the internal network. For example, the functional update information item provided for the one or plurality of entities of the first group of entities of the internal network respectively differ from each other at least partially by the functional update time and/or the functional update time period.

This is for example also advantageous when the one or plurality of entities of the first group of entities of the internal network are devices for controlling a light means in order to prevent the light means from all being activated simultaneously (which e.g. could lead to a breakdown of the power supply network of the light means and/or the lighting network).

According to an exemplary embodiment of the first, second and/or third aspect of the invention, the internal network is a closed network (e.g. a private network). A closed network serves for example exclusively to transmit information between entities of a closed group of entities. For example, only entities of the closed group of entities can transmit information via the closed network. A closed network can for example be separated physically and/or logically from other networks. An example of a closed network is for example a virtual private network (VPN).

For example, the second server is an entity of the closed group of entities.

For example, the internal network comprises at least partially a machine to machine network. For example, the internal network is at least partially a machine to machine network. Machine to machine (M2M) denotes the automated information exchange between end devices such as sensors, machines, automatic machines, vehicles or containers and/or with a server device e.g. using the internet and different access networks such as mobile networks.

For example, the internal network at least partially comprises a VPN network.

For example, the internal network is at least partially the network of a wireless infrastructure outdoors (e.g. a system for recording information outdoors and/or a lighting system). In the present case, a wireless infrastructure outdoors should be understood for example as an infrastructure (e.g. a network) for at least partially wireless transmission of information (e.g. of data) between different entities of one or a plurality of systems.

For example, the internal network at least partially comprises a wired network such as a PoE network. For example, one or a plurality of entities of the internal network is connected via a PoE network to a PoE switch and the PE switch is for example connected via a further network (e.g. the internet and/or a VPN network) to the second server. For example, the PoE switch is part of an entity of the internal network.

For example, the internal network at least partially comprises the network of a lighting system. As described above, the entities of the internal network are for example part of a lighting system wherein the entities of the internal network for example comprise one or a plurality of devices for controlling a lighting means and the second server. For example, the devices for controlling a lighting means are at least partially connected via a wired network such as a PoE network or a PLC network to the second server and/or the second server device. This is for example advantageous in order to be able to use the same connection (e.g. the same wire and/or the same cable) for the power supply of a device for controlling light means and for communication with this device for controlling a light means. It is also conceivable for the devices for controlling a light means to be at least partially connected via a wireless network to the second server and/or the second server device. For example, the devices for controlling a light means are connected via a machine to machine network and/or a VPN network to the second server and/or to the second server device. The machine to machine network and/or the VPN network extend for example via one or a plurality of wired networks and/or one or a plurality of wireless networks.

For example, the second server is connected to the first server and/or the first server device. For example, there is no direct connection of the devices for controlling a light means to the first server and/or the first server device. For example, the devices for controlling a light means are connected (e.g. only) via the second server to the first server and/or the first server device.

According to an exemplary embodiment of the first, second and/or third aspect of the invention, one or a plurality of entities of the internal network comprise one or a plurality of communication means which are configured to provide an access point of a wireless network (e.g. an access point of a WiFi hotspot).

According to an exemplary embodiment of the first, second and/or third aspect of the invention, the external network is an open network (e.g. a public network). An open network for example serves for transmitting information between entities of an open group of entities. For example, all entities of the open group of entities can join (e.g. if they are configured to send and/or receive information via the open network) and transmit information via the open network. An example of an open network is for example the internet. For example, one or a plurality of servers of the external network are connected to the first server (e.g. the first server device).

For example, a server of the external network receives the first information item and/or the information item based on the first information item from the first server and provides, as described above, a network portal for access to the first information item and/or the information item based on the first information item and/or to retrieve the first information item and/or the information item based on the first information item by the entities of the first group of entities of the external network. For example, a server of the external network receives the second information item from the entity of the second group of entities of the external network and sends the second information item to the first server (e.g. the first server device).

The above-described exemplary embodiments and exemplary configurations of the present invention should also be understood as being disclosed in all combinations with each other.

### BRIEF DESCRIPTION OF THE SEVERAL VIEWS OF THE DRAWING

Further advantageous exemplary configurations of the invention can be inferred from the following detailed description of some exemplary embodiments of the present invention, in particular in connection with the figures. The figures accompanying the application should, however, only serve the purpose of illustrating, but not determining the scope of protection of the invention. The accompanying drawings are not necessarily true to scale and are supposed to merely reflect the general concept of the present invention by way of example. In particular, features contained in the figures should not be considered as a necessary part of the present invention. They show:

FIG. 1 is a block diagram of an exemplary embodiment of a system according to the third aspect of the invention;

FIG. 2a is a block diagram of an exemplary embodiment of a server according to the first aspect of the invention;

FIG. 2b is a block diagram of an exemplary embodiment of a server according to the second aspect of the invention;

FIG. 3a shows a flow diagram with steps of an exemplary embodiment of the method according to the first aspect of the invention;

FIG. 3b shows a flow diagram with steps of an exemplary embodiment of the method according to the first aspect of the invention;

FIGS. 4a and 4b shows flow diagrams with communication steps of an exemplary embodiment of the method according to the first aspect of the invention;

FIG. 5a shows a flow diagram with steps of an exemplary embodiment of the method according to the second aspect of the invention; and

FIG. 5b shows a flow diagram with steps of an exemplary embodiment of the method according to the second aspect of the invention.

### DETAILED DESCRIPTION OF EMBODIMENTS OF THE INVENTION

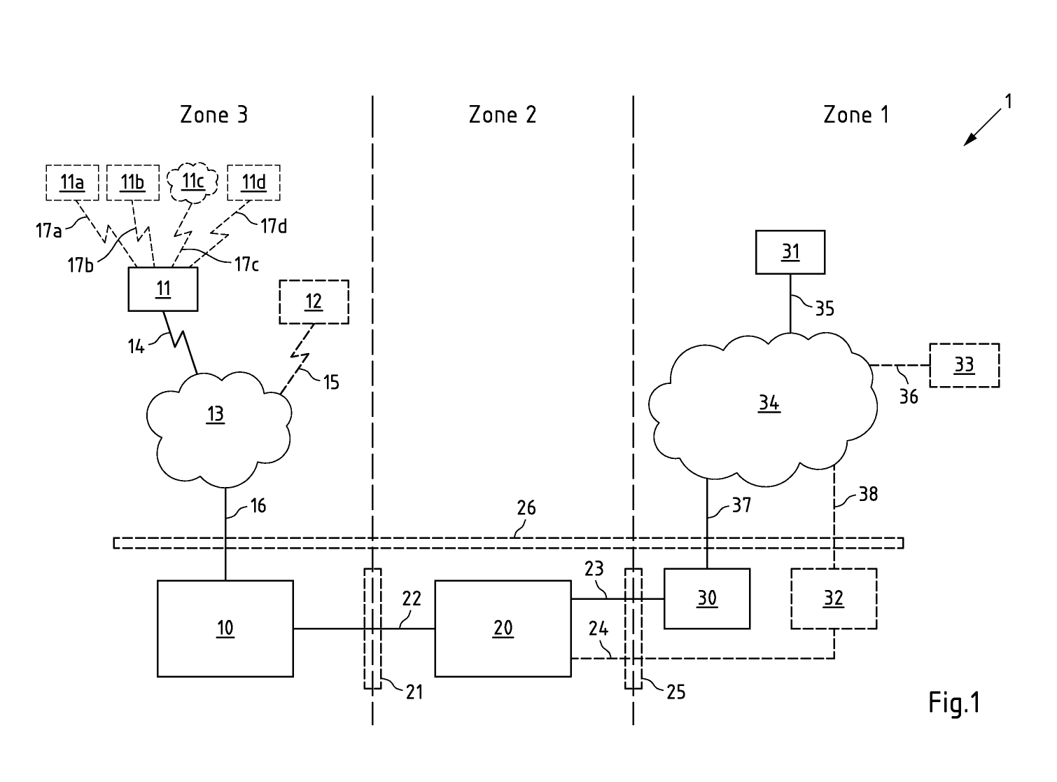

FIG. 1 shows a block diagram of an exemplary embodiment of a system 1 according to the third aspect of the invention. The system 1 is divided into 3 zones which are captioned in FIG. 1 with zone 1, zone 2 and zone 3. The zones correspond for example to different levels of protection. Zone 3 for example has the highest level of protection, zone 2 the medium level of protection and zone 1 the lowest level of protection.

Zone 3 of the system 1 comprises the server 10 and entities 11 and 12 of an internal network 13. Server 10 is an entity of the internal network. Server 10 is a second server according to the second and third aspect of the invention.

In FIG. 1, the server 10 and entity 11 as well as the optional entity 12 are depicted by way of example. However, it is conceivable for zone 3 to comprise one or a plurality of further optional entities of the internal network in addition to the optional entity 12. It is also further conceivable for zone 3 of the system 1 to comprise only one entity of the internal network (e.g. the single entity of the internal network). For example, zone 3 of the system 1 comprises all entities of the internal network.

The server 10 and the entities 11 and 12 of the internal network 13 are connected to each other via respective network connections 14, 15 and 16 of the internal network 13 to the internal network 13 and via the internal network 13. The network connections 14 and 15 are depicted in FIG. 1 by way of example as wireless network connections and the network connection 16 is depicted by way of example as a wired network connection. However, it is also conceivable for the network connections 14 and 15 to be at least partially wireless network connections and/or the network connection 16 to be at least partially a wireless network connection.

For example, the internal network 13 is a closed network (e.g. a private network). For example, only the server 10 and the entities 11 and 12 of the internal network 13 can transmit information via the internal network 13 (e.g. send and/or receive). For example, information is transmitted encrypted in the internal network (e.g. between the server 10 and/or the entities 11 and 12).

In FIG. 1, the optional entities 11a and 11b as well as the optional network 11c and the optional component 11d are also depicted which are connected to entity 11 of the internal network 13 via respectively one of the wireless network connections 17a, 17b, 17c and 17d. It is conceivable for the entity to be connected with further optional entities, components and/or networks (e.g. 1 to n entities, components and/or networks). For example, the wireless network connections 17a, 17b, 17c and 17d are network connections of a local wireless network. For example, the wireless network connections 17a, 17b, 17c and 17d are protected network connections via a local wireless network (e.g. VPN connections).

For example, the entity 11 and the optional entities 11a and 11b form a group of entities of the internal network wherein entity 11 is for example a master entity and the entities 11a and 11b are for example slave entities. For example, the slave entities of such a group are only indirectly connected to the internal network 13 via the master entity of the group (e.g. connected via the network connection 17a and/or 17b to the master entity and via the master entity to the internal network 13). For example, the slave entities of such a group can only indirectly send and/or receive information via the master entity of the group via the internal network 13.

For example, the entity 11 can be connected via the network connections 17c to a network 11c different from the internal network such as a local wireless network (e.g. a mesh network and/or an adhoc network).

For example, the entity 11 can be connected via the network connection 17d to an external component 11d such as a sensor.

For example, the internal network 13 comprises a first network (e.g. a wireless network) and a second network (e.g. a wired network). For example, the first network is a wireless machine to machine network. For example, the second network is a VPN network on which a public network such as the internet is built.

For example, the internal network 13 is the network of a lighting system. For example, the server 10 is a backend server of the lighting system. For example, the entity 11 and the optional entities 11a, 11b and 12 are devices for controlling a light means which are connected to one or a plurality of light means. For example, the server 10 is configured to transmit information via the internal network 13 to the entities 11 and 12. For example, the server 10 is configured to transmit information via the internal network 13 and the entity 11 to the entities 11a and 11b. For example, the server 10 has cryptographic keys in zone 3 which are for example necessary for transmitting information to the entities 11, 11a, 11b and 12 of the internal network. For example, these cryptographic keys are necessary in order to transmit an information item (e.g. a control information item) from the server 10 via the internal network 34 to the entities 11, 11a, 11b and 12. For example, the server 10 in zone 3 can communicate exclusively via network connection 16 with the internal network 13 and via connection 22 with the server 20.

Zone 1 of the system 1 comprises the server 30 and 32 as well as entities 31 and 33 of the external network 34. In FIG. 1, the server 30 and the entity 31 as well as the optional server 32 and the optional entity 33 are depicted by way of example. However, it is conceivable for zone 1 to comprise one or a plurality of optional servers and/or entities of the external network in addition to the optional server 32 and the optional entity 33. It is also further conceivable for zone 1 of the system 1 to comprise only one entity of the external network.

The servers 30 and 32 and the entities 31 and 33 of the external network 34 are connected to each other via respective network connections 35, 36, 37 and 38 of the external network 34 to the external network 34 and via the external network 34. The network connections 35, 36, 37 and 38 are depicted in FIG. 1 by way of example as a wired network connection. However, it is also conceivable for the network connections 35, 36, 37 and 38 to be at least partially wireless network connections.

For example, the external network 34 is an open network (e.g. a public network). For example, the servers 30 and 32 as well as the entities 31 and 33 of the external network 34 can transmit information via the external network 34 (e.g. send and/or receive).

For example, the external network 34 comprises the internet. For example, the servers 30 and 32 are internet servers. For example, the entities 31 and 33 are internet-capable user devices such as smartphones, computers, notebook computers and/or tablet computers. For example, the servers 30 and 32 are configured to receive information from the server 20 and to provide information to access and/or retrieve via the external network 34 by entities of one or a plurality of groups of entities of the external network 34 and/or to receive and send to the server 20 information from entities of one or a plurality of groups of entities of the external network 34 via the external network 34. For example, the servers 30 and 32 are configured to provide a network portal as a user interface. For example, the servers 30 and 32 are user interface servers. However, it is also conceivable for the servers 20 and 32 to be configured to provide a programming interface (e.g. an API interface). For example, the server 30 and 32 are user interface servers.

Zone 2 of the system 1 comprises a server 20. The server 20 is a first server according to the first and third aspect of the invention. It is conceivable for zone 2 to comprise one or a plurality of further first servers in addition to the server 20.

The server 20 is connected via the connection 22 to the server 10 of the internal network and via connections 23 and 24 to the servers 30 and 32 of the external network 34. The connections 22, 23 and 24 are for example respectively one network connection. For example, the connection 22 is a network connection via a closed network (e.g. a VPN network) via which only the server 10 and the server 20 can transmit information. For example, the connection 23 is a network connection via a closed network (e.g. a VPN network) via which only the server 30 and the server 20 can transmit information. For example, the connection 24 is a network connection via a closed network (e.g. a VPN network) via which only the entity 31 and the server 20 can transmit information.

For example, optional firewalls 22, 25 and 26 are arranged in some or all connections of the server 20, of the server 10 and of the servers 30 and 32. This can for example be hardware-based and/or software-based firewalls. The firewalls effect an additional separation of the zones. For example, a firewall 25 is arranged in the connections 23 and 24. For example, a firewall 21 is arranged in the connection 22. It is also conceivable additionally or alternatively for diode servers to be at least partially arranged in these connections.

The entities 11 and 12 of the internal network 13 (in zone 3) are for example connected exclusively via the server 10 (in zone 3) and the server 20 (in zone 2) to the servers 30 and 32 as well as the entities 31 and 33 of the external network 34 (in zone 3). For example, information can be transmitted between the entities 11 and 12 of the internal network 13 and the servers 30 and 32 as well as the entities 31 and 33 of the external network 34 exclusively via the server 10 and the server 20. The server 20 thus provides for example an interface between the internal network 13 and the external network 34.

For example, users cannot communicate directly with the entities of the internal network 13 (e.g. the lighting system) via the entities of the external network 34, but rather only via the server 20 with the entities of the internal network. If the internal network 13, as described above by way of example, is the network of a lighting system, control information items for the lighting system can for example be transmitted only via the server 20 and via the server 10 (e.g. a backend server of the lighting system) to the entities 11 and 12 (e.g. devices for controlling a light means). The server 20 is for example an analytical server.

In FIG. 1, the server 10 and the server 20 are separated and depicted connected only by connection 22. However, it is also conceivable for the server 10 and the server 20 to be the same servers. For example, the functions of the server 10 and the server 20 can be provided in this case by two virtualised server instances of the same server. Alternatively or additionally, it is also conceivable for the servers 30 and 32 and the server 20 to be the same servers. For example, the functions of the servers 30 and 32 and the server 20 can be provided in this case by three virtualised server instances of the same server.

For example, the servers 10 and 20, the entities 11, 12 and the internal network 13 as well as the network connections 14, 15, 16 form an intelligent infrastructure for the outdoors for example for controlling and administering components of a distributed system such as a lighting system or an automation and/or production system (e.g. an industry 4.0 infrastructure). For example, the optional entities 11a and 11b are also part of such an infrastructure.

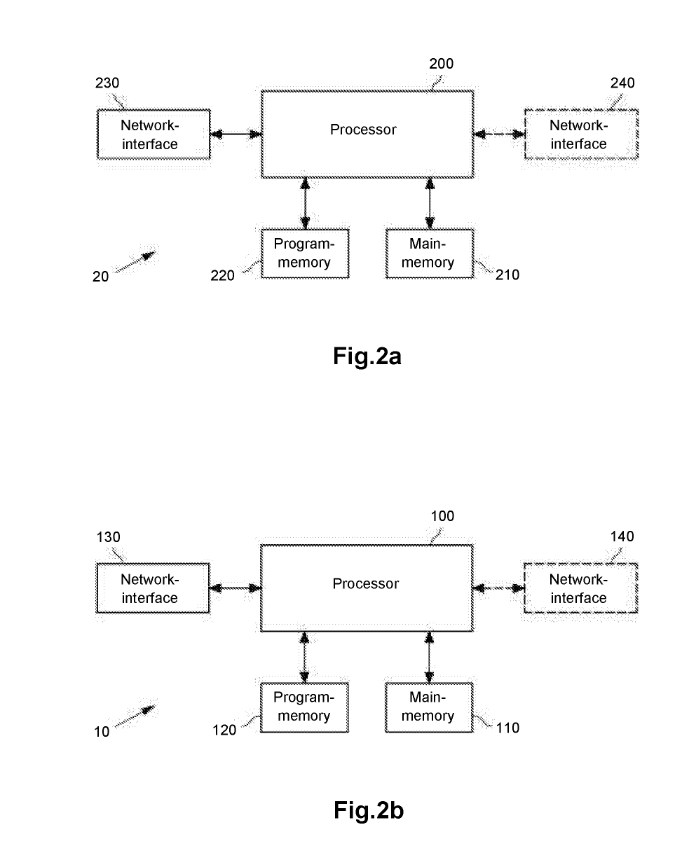

FIG. 2a shows a block diagram of an exemplary embodiment of the first server 20 according to the first and third aspect of the invention.

The processor 200 is in particular designed as a microprocessor, microcontrol unit such as a microcontroller, digital signal processor (DSP), application-specific integrated circuit (ASIC) or field programmable gate array (FPGA).

The processor 200 performs program instructions, which are stored in program memory 220, and stores for example intermediate results or similar in main memory 210. For example, the program memory 220 is a non-volatile memory such a flash memory, a magnetic memory, an EEPROM memory (electrically erasable programmable read-only memory) and/or an optical memory. The main memory 210 is for example a volatile or non-volatile memory, in particular a memory with random access (RAM) such as a static RAM memory (SRAM), a dynamic RAM memory (DRAM), a ferroelectric RAM memory (FeRAM) and/or a magnetic RAM memory (MRAM).

The program memory 220 is preferably a local data carrier fixedly connected to the server 20. Data carriers fixedly connected to the server 20 are for example hard discs which are built into the server 20. Alternatively, the data carrier can for example also be a data carrier that can be detachably connected to the server 20 such as a memory stick, a removable disc, a portable hard disc, a CD, a DVD and/or a diskette.

The operating system of server 20 is stored in the program memory 220 which is loaded at least partially in the main memory when the server 20 starts and is executed by the processor 200. In particular, when the server 20 starts, a part of the core of the operating system in the main memory 210 is loaded and executed by the processor 200. The operating system of the server 20 is preferably a Windows, UNIX, Linux, Android and/or iOS operating system. The operating system of the server 20 is preferably different from the operating system of the server 10 in order to make an attack on the server 20 and the server 10 difficult.

Only the operating system enables the use of the server 20 for data processing. It administers for example operating means such as main memory 210 and program memory 220 and network interface 230 as well as optional network interface 240, provides, amongst other things, functions fundamental to other programs by programming interfaces and controls the performance of programs.

Program instructions are for example further stored in program memory 220 which cause the processor 220, when it performs the program instructions, to at least partially perform and/or control the method according to the first and third aspect of the invention. For example, a first server program is stored in program memory 220 according to the first aspect of the invention.

The processor 200 controls the network interface 230 and the optional network interface 240 wherein the control of the network interfaces 230 and 240 is for example enabled by a device driver program which is part of the core of the operating system. Network interfaces 230 and 240 are for example respectively a network card, a network module and/or a modem and are respectively configured to establish one or a plurality of connections of the control device 20 to a network. Network interfaces 230 and 240 are for example respectively configured to receive information via the network and forward it to the processor 200 and/or to receive information from the processor 200 and send it via the network.

For example, network interface 230 is configured to send information to one or a plurality of entities of an external network (e.g. to one or a plurality of servers/entities 30, 31, 32 and 33 of the external network 34) and/or to receive information from one or a plurality of entities of the external network (e.g. from one or a plurality of servers/entities 30, 31, 32 and 33 of the external network 34). For example, network interface 230 is configured to send and/or receive information via connections 23 and 24. For example, optional network interface 240 is configured to send information to one or a plurality of entities of an internal network (e.g. to server 10) and/or to receive information from one or a plurality of entities of the internal network (e.g. from the server 10). For example, optional network interface 240 is configured to send and/or receive information via connection 22. However, it is also conceivable for server device 20 to comprise only one network interface which is configured corresponding to the network interface 230 and the network interface 240.

FIG. 2a shows a block diagram of an exemplary embodiment of the second server 10 according to the first and third aspect of the invention. The structure of the server 10 corresponds for example to the structure of the server 20.

The processor 100 performs program instructions, which are stored in program memory 120, and stores for example intermediate results or similar in main memory 110. For example, the program memory 120 is a non-volatile memory such a flash memory, a magnetic memory, an EEPROM memory (electrically erasable programmable read-only memory) and/or an optical memory. The main memory 110 is for example a volatile or non-volatile memory, in particular a memory with random access (RAM) such as a static RAM memory (SRAM), a dynamic RAM memory (DRAM), a ferroelectric RAM memory (FeRAM) and/or a magnetic RAM memory (MRAM).

The program memory 120 is preferably a local data carrier fixedly connected to the server 10. Data carriers fixedly connected to the server 10 are for example hard discs which are built into the server 10. Alternatively, the data carrier can for example also be a data carrier that can be detachably connected to the server 10 such as a memory stick, a removable disc, a portable hard disc, a CD, a DVD and/or a diskette.

The operating system of server 10 is stored in the program memory 120 which is loaded at least partially in the main memory 110 when the server 10 starts and is executed by the processor 100. In particular, when the server 10 starts, a part of the core of the operating system in the main memory 110 is loaded and executed by the processor 100. The operating system of the server 10 is preferably a Windows, UNIX, Linux, Android and/or iOS operating system. The operating system of the server 10 is preferably different from the operating system of the server 20 in order to make an attack on the server 10 and the server 20 difficult.

Only the operating system enables the use of the server 10 for data processing. It administers for example operating means such as main memory 110 and program memory 120 and network interface 130 as well as optional network interface 140, provides, amongst other things, functions fundamental to other programs by programming interfaces and controls the performance of programs.

Program instructions are for example further stored in program memory 120 which cause the processor 120, when it performs the program instructions, to at least partially perform and/or control the method according to the first and third aspect of the invention. For example, a first server program is stored in program memory 120 according to the first aspect of the invention.

The processor 100 controls the network interface 130 and the optional network interface 140 wherein the control of the network interfaces 130 and 140 is for example enabled by a device driver program which is part of the core of the operating system. Network interfaces 130 and 140 are for example respectively a network card, a network module and/or a modem and are respectively configured to establish one or a plurality of connections of the control device 10 to a network. Network interfaces 130 and 140 are for example respectively configured to receive information via the network and forward it to the processor 100 and/or to receive information from the processor 100 and send it via the network.

For example, network interface 130 is configured to send information to one or a plurality of further entities of the internal network (e.g. to one or a plurality of entities 11 and 12 of the internal network 13) and/or to receive information from one or a plurality of further entities of the external network (e.g. from one or a plurality of entities 11 and 12 of the internal network 13). For example, network interface 130 is configured to send and/or receive information via network connection 16. For example, optional network interface 140 is configured to send information to the server 20 and/or receive information via the server 20. For example, optional network interface 140 is configured to send and/or receive information via connection 22. However, it is also conceivable for server 10 to comprise only one network interface which is configured corresponding to the network interface 130 and the network interface 140.

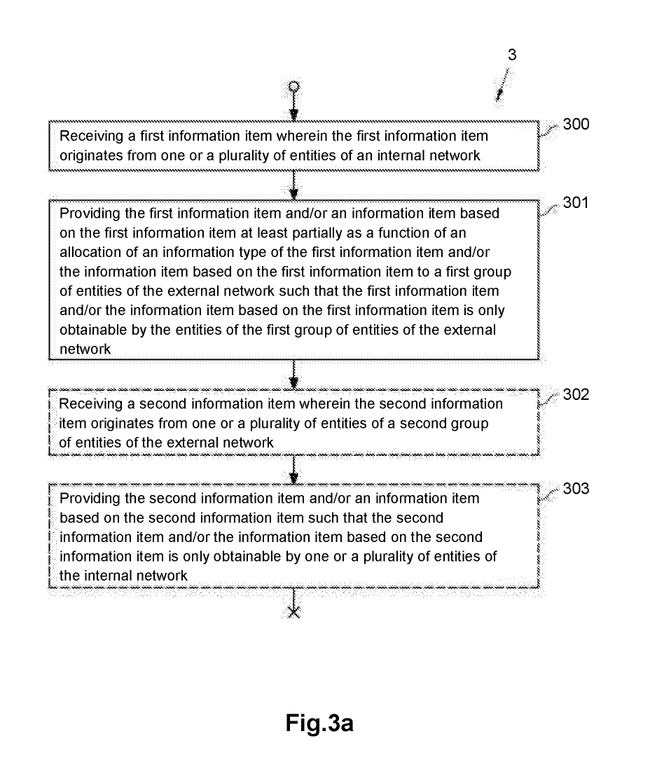

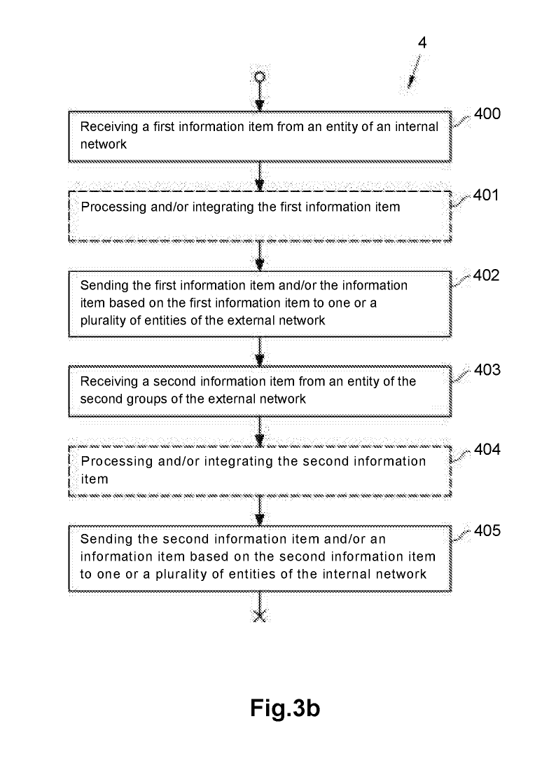

FIG. 3a shows a flow diagram 3 with steps of an exemplary embodiment of the method according to the first aspect of the invention which are performed and/or controlled by the server 20 according to FIG. 2a. For example, program instructions of a program stored in the program memory 220, which is executed by the processor 200, cause the server 20 to perform and/or control the steps of the flow diagram 3. The steps of the flow diagram 3 are described by way of example below in connection with the system 1 depicted in FIG. 1. The steps of the flow diagram 3 can for example also be part of an exemplary embodiment of the method according to the third aspect of the invention (e.g. together with the steps of the flow diagrams 6 and/or 7 described below).

In step 300, a first information item is received by the server 20 wherein the first information item originates from one or a plurality of entities of the internal network 13.

For example, the first information item originates from the entity 11 of the internal network 13. As described above, in the present case, an information item should for example be understood as originating from an entity if the information item was at least partially generated and/or recorded by the entity and/or a means of the entity. For example, the entity 11 and/or a means of the entity 11 at least partially generated and/or created the first information item. For example, the first information item is an environmental information item at least partially recorded by a sensor of the entity 11 (e.g. a brightness information item). However, it is also conceivable for the first information item to for example be a status information item generated at least partially by the entity 11.

For example, the server 20 receives the first information item from the server 10 or one of the entities 11, 11a, 11b and 12 of the internal network 13.

For example, the entity 11 sends the recorded and/or generated first information item via the internal network 13 (e.g. via the network connections 14 and 16 of the internal network 13) to the server 10. For example, the server 10 receives the first information item via the internal network 13 from the entity 11 and sends it via the connection 22 to the server 20. For example, the first information item is received in step 300 by the server 10 via the connection 22 to the server 20.

In step 301 the first information item or an information item based on the first information item is at least partially provided by the server 20 as a function of an allocation of an information type of the first information item and/or the information item based on the first information item to a first group of entities of the external network 34 such that the first information item and/or the information item based on the first information item is obtainable only by the entities of the first group of entities of the external network 34.

In the present case, an information item should, as described above, for example be understood as obtainable by an entity if the information item is obtainable at the entity. For example, an information item is obtainable by an entity if the information item can be received, read, recorded, retrieved and/or decrypted.

The information based on the first information item is for example at least partially the result of processing and/or integration of the first information item.

As described above, different groups of entities of the external network 13 are for example respectively allocated to different information types. For example, only the entities of a group of entities of the external network have the right to obtain information items of the information type allocated to the group of entities of the external network. A group of entities of the external network for example comprises all entities of the external network with the right to obtain information of a certain information type. For example, rights information and/or allocation information are correspondingly stored in the program memory 220 of the server 20.

For example, the entity 31 of the external network 34 has the right to obtain information of the information type of the first information item and/or the information item based on the first information item (e.g. environmental information items). For example, the entity 31 is an entity of the first group of entities of the external network 34 which have the right to obtain information of the information type of the first information item and/or the information item based on the first information item (further possible entities of this group of entities of the external network are not depicted). In this case, the first information item and/or the information item based on the first information item is for example provided in step 301 by the server 20 such that it is obtainable by the entity 31 of the external network 34 (e.g. is receivable and/or retrievable by the entity 31 of the external network 34). For example, the first information item is in this case sent by the server 20 to the server 30 which is for example configured to provide the first information item for accessing and/or retrieving via the external network 34 by the entity 31 (e.g. via the network connections 35 and 37 of the external network 34) and by further entities of the first group of entities of the external network. However, it is also conceivable for the first information item and/or the information item based on the first information item to be sent from the server 20 (e.g. directly) to the entity 31 and further entities of this group of entities of the external network. For example, the first information item is provided in step 301 such that it is not obtainable by entities of the external network 34 that are different from the first group of entities of the external network (e.g. the entity 33 of the external network 34).

For example, the entity 33 of the external network 34 only has the right to obtain information of an information type different from the information type of the first information item (e.g. status information). For example, the entity 33 is an entity of a first group of entities of the external network 34 which have the right to obtain information of the information type that is different from the information type of the first information item (further possible entities of this group of entities of the external network are for example not depicted). If an information item of such an information type is obtained in step 300 by the server 20, it is for example provided in step 301 such that it is obtainable by the entity 33 of the external network 34 (e.g. is receivable and/or retrievable by the entity 33 of the external network 34). For example, the information is in this case sent to entity 32 which is for example configured to provide information for accessing and/or retrieving via the external network 34 by the entity 33 (e.g. via the network connections 36 and 38 of the external network 34).

In optional step 302, a second information item is received by the server 20 wherein the second information item originates from an entity of a second group of entities of the external network 34.

For example, the second information item originates from the entity 31 of the external network 34. For example, the second information item is recorded and/or generated at least partially by the entity 31. For example, the second information item is at least partially a user input recorded by the entity 31.

For example, only the entities of the second group of entities of the external network 34 have the right to transmit information via the server 20 to one or a plurality of entities of the internal network 13. For example, the entity 31 of the external network 34 is an entity of the second group of entities of the external network 34 which have the right to transmit information via the server 20 to one or a plurality of entities of the internal network 13 (further possible entities of this group of entities of the external network are not depicted).

For example, the second information item is received in step 302 from the server 30 by the server 20 (e.g. via network connection 23). For example, the server 30 of the external network is configured to receive the second information item from an entity of the second group of entities of the external network and send it to the server 20. However, it is also conceivable for the second information item to be received in step 302 from the entity 31 by the server 20.

In optional step 303, the second information item and/or an information item based on the second information item is provided by the server 20 such that the second information item is only obtainable by one or a plurality of entities of the internal network 13.

In the present case, an information item should, as described above, for example be understood as obtainable by an entity if the information item can be obtained by the entity. For example, an information item is obtainbale by an entity if the information item can be received, read, recorded, retrieved and/or decrypted by the entity. For example, the second information item and/or the information item based on the second information item is provided in step 303 for accessing and/or retrieving by the server 10 of the internal network 34. For example, the second information item and/or the information item based on the second information item is sent in step 303 to the server 10 which is configured to transmit information via the internal network 13 to entities 11 and 12. For example, the second information item and/or the information item based on the second information item is sent in step 303 only to the server 10 when the server 10 retrieves and/or accesses the second information item.

The information item based on the second information item is for example at least partially the result of processing and/or integration of the second information item.

FIG. 3b shows a flow diagram 4 with steps of an exemplary embodiment of the method according to the first aspect of the invention which are performed and/or controlled by the server 20 according to FIG. 2a. For example, program instructions of a computer program stored in the program memory 220, which is executed by the processor 200, cause the server 20 to perform and/or control the steps of the flow diagram 4. The steps of the flow diagram 4 are described by way of example below in connection with the system 1 depicted in FIG. 1. The steps of the flow diagram 4 can for example also be part of an exemplary embodiment of the method according to the third aspect of the invention (e.g. together with the steps of the flow diagrams 6 and/or 7 described below).

In step 400, a first information item is received by the server 20 from the server 10 of the internal network 13 (e.g. via connection 22). As described in detail for step 300, the first information item originates for example from the entity 11 of the internal network.

In optional step 401, the first information item is processed and/or integrated with a further information item.

In the present case, processing of the first information item is for example understood as organising, analysing and/or changing the first information item. The organisation and/or changing of the first information item can for example take place by using a data processing algorithm on the first information item. For example, the images of an observation camera can be sent with poor resolution (e.g. for reasons of data protection), unless certain events occur such as for example an unattended bag.

In the present case, the integration of the first information item with a further information item should for example be understood as the first information item and the further information being aggregated, analysed and/or evaluated. For example, the existence and direction of a device in a circular environment around the radiation sensor can be determined by recording Bluetooth signals by way of a radiation sensor for Bluetooth signals and the position and structure of the object can be recorded by an ultrasound sensor. By integrating this information, it can be evaluated whether a pedestrian, a car and/or another vehicle is moving in a certain direction. Other integrations of information can serve as an example for providing marketing information (such as for example when a business would like to give discounts to a certain number of customers or would like to evaluate how many customers are located nearby and how often they have already stayed there). Vibrations can also for example be recorded and be evaluated by comparison with the position and history of vibration information at other positions to determine whether they are vibrations due to an earthquake or for example vibrations due to passing traffic.

Generally, integrated and/or processed information mainly constitutes a greater additional value than information recorded by individual sensors. The result of this value-added service can in turn for example lead to even more complex processes which can subsequently be performed. For example, the information flow (e.g. the information flow to a passing pedestrian) may be different on a nice sunny day than during an earthquake or when there is bad weather. The response to the sent messages can for example in turn be recorded, processed and evaluated in order to for example be designed differently and more effectively when the events reoccur.

The result of the processing and/or integration in step 401 is for example an information item based on the first information item.

In step 402, the first information item and/or the information item based on the first information item is sent to one or a plurality of entities of the external network. As described above, only the entities of the first group of entities of the external network 34 for example have the right to obtain information items of the information type of the first information item and/or the information item based on the first information item. For example, the entity 31 of the external network 34 has the right to obtain information of the information type of the first information item and/or the information item based on the first information item. For example, the first information item and/or the information item based on the first information item is in this case sent in step 402 to the entity 30 which is for example configured to provide the first information item and/or the information item based on the first information item for accessing and/or retrieving via the external network 34 by the entity 31 (e.g. via the network connections 35 and 37 of the external network 34) and/or further entities of the first group of entities of the external network. For example, the server 30 of the external network is configured to provide a network portal for authenticating the entities of the first group of entities of the external network and/or for accessing the first information item and/or the information item based on the first information item by the authenticated entities of the first group of entities of the external network. For example, the authentication of the entities of the first group of entities comprises checking for each of the entities (e.g. at least partially as a function of an authentication feature) to determine whether the respective entity has the right to obtain information of the information type of the first information item and/or the information item based on the first information item.

In an optional step 403, a second information item is received from an entity of the external network 34 by the server 20. For example, the second information item is received in step 403, as described in detail in step 302, by the server 20 from the server 30 (e.g. via network connection 23).

As described above in step 302, for example, only the entities of the second group of entities of the external network 34 have the right to transmit information via the server 20 to one or a plurality of entities of the internal network 13. For example, the entity 31 of the external network 34 has the right to transmit information via the server 20 to one or a plurality of entities of the internal network 13. For example, the server 30 of the external network is configured to provide a network portal for authenticating the entities of the second group of entities of the external network 34 and for receiving the second information item from one of the authenticated entities of the second group of entities of the external network 34. For example, the server 30 of the external network is further configured to send the second information item received by one of the authenticated entities of the second group of entities of the external network to the server 20. For example, the authentication of the entities of the second group of entities comprises checking for each of the entities (e.g. at least partially as a function of an authentication feature) to determine whether the respective entity has the right to transmit information via the server 20 to one or a plurality of entities of the internal network 13.

In an optional step 404, the second information item is processed by the server 20 and/or integrated with a further information item.

In the present case, processing of the second information item should for example be understood as organising, analysing and/or changing the second information item. The organisation, analysis and/or changing of the second information item can for example take place by using a checking algorithm and/or a data processing algorithm on the second information item. In the present case, the integration of the second information item with a further information item should for example be understood as the second information item and the further information item being aggregated, analysed and/or evaluated.

The result of the processing and/or integration in step 405 is for example an information item based on the second information item.

In step 405, the second information item and/or the information item based on the second information item is sent to one or a plurality of entities of the internal network. For example, the second information item and/or the information item based on the second information item is sent in step 405 only to one or a plurality of entities of the internal network when the second information item originates from an (e.g. authenticated) entity of the second group of entities of the external network.

For example, the second information item and/or the information item based on the second information item is sent in step 405 to the server 10 of the internal network 13 which is configured to transmit information via the internal network 13 to entities 11 and 12. For example, the second information item and/or the information item based on the second information item is sent, as described above in detail in step 303, only to the server 10 when the server 10 retrieves and/or accesses the second information item and/or the information item based on the second information item.

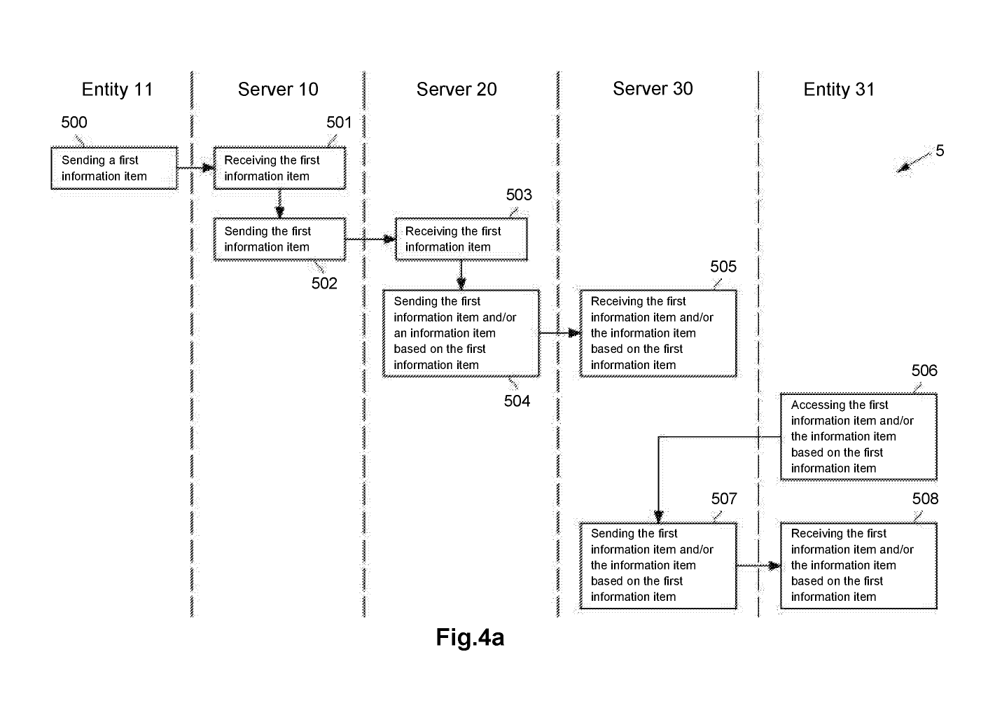

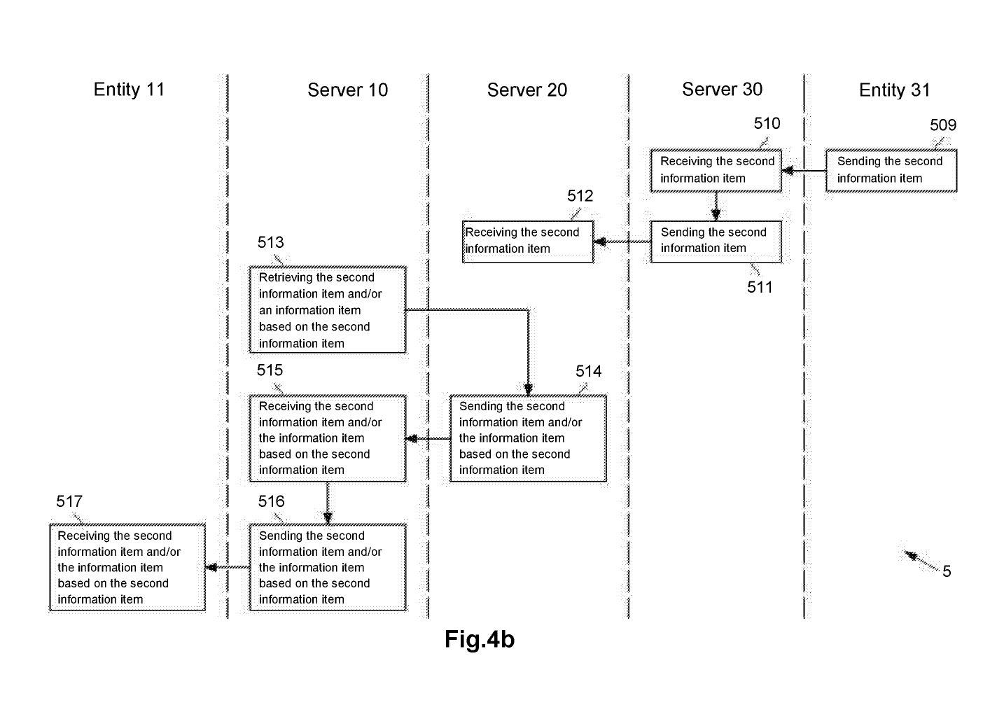

FIG. 4a and FIG. 4b show a flow diagram 5 with communication steps of an exemplary embodiment of the method according to the first aspect of the invention which take place in the system 1 according to FIG. 1.

In step 500, the entity 11 of the internal network 13 sends a first information item to the server 10 of the internal network 13. For example, the first information item is an environmental information item at least partially recorded by a sensor of the entity 11 (e.g. a brightness information item). However, it is also conceivable for the first information item to for example be a status information item generated at least partially by the entity 11. For example, the entity 11 sends the recorded and/or generated first information item via the internal network 13 (e.g. via the network connections 14 and 16 of the internal network 13) to the server 10.

In step 501, the first information item is received by the server 10 of the internal network 13. For example, the server 10 receives the first information item in step 501 via the internal network 13 from the entity 11 (e.g. via the network connections 14 and 16 of the internal network 13).

In step 502, the first information item is sent from the entity 10 of the internal network 13 to the server 20 (e.g. via the connection 22).

In step 503, the first information item is received by the server 20 (e.g. via the connection 22). This for example corresponds at least substantially to the above-described step 400. For example, the first information item is subsequently processed and/or integrated by the server 20.

In step 504, the first information item and/or an information item based on the first information item is sent from the server 20 to the entity 30 of the external network 34 (e.g. via connection 23). This for example corresponds at least substantially to the above-described step 402.

As described above, only the entities of the first group of entities of the external network 34 for example have the right to obtain information items of the information type of the first information item and/or the information item based on the first information item. For example, the server 30 of the external network is configured to provide a network portal for authenticating the entities of the first group of entities of the external network and/or for accessing the first information item and/or the information item based on the first information item by the authenticated entities of the first group of entities of the external network.

For example, the authentication of the entities of the first group of entities comprises checking for each of the entities (e.g. at least partially as a function of an authentication feature) to determine whether the respective entity has the right to obtain information of the information type of the first information item and/or the information item based on the first information item. For example, the entity 31 of the external network 34 has the right to obtain information of the information type of the first information item and/or the information item based on the first information item.

In step 505, the first information item and/or the information item based on the first information item is received by the entity 30 of the external network 34 (e.g. via connection 23). For example, the first information item and/or the information item based on the first information item is subsequently provided by the server 30 via the network portal for accessing and/or retrieving via the external network 34 by (e.g. authenticated) entities of the first group of entities of the external network.

In step 506, the entity 31 accesses the first information item and/or the information item based on the first information item (e.g. via the network connections 35 and 37, e.g. via the network portal).

In step 507, the first information item and/or the information item based on the first information item is sent in response to the access to the first information item and/or the information item based on the first information item in step 506 from the server 30 to the first entity 31 of the external network 34 (e.g. via the network connections 35 and 37).

For example, the server 30 authenticates the entity 31 of the external network 34 first and subsequently sends the first information item and/or the information item based on the first information item in response to the access to the first information item and/or the information item based on the first information item in step 506 to the authenticated first entity 31 of the external network 34.

In step 508, the first information item and/or the information item based on the first information item is received by the entity 31 from the server 30 (e.g. via connection 37).

In step 509, a second information item is sent by the entity 31 to the server 30 (e.g. via the network connections 35 and 37). For example, the second information item is recorded and/or generated at least partially by the entity 31. For example, the second information item is at least partially a user input recorded by the entity 31.

For example, the server 30 of the external network is configured to provide a network portal for authenticating the entities of the second group of entities of the external network and for receiving the second information item from one of the authenticated entities of the second group of entities of the external network. For example, the authentication of the entities of the second group of entities comprises checking for each of the entities (e.g. at least partially as a function of an authentication feature) to determine whether the respective entity has the right to transmit information via the server 20 to one or a plurality of entities of the internal network 13. For example, only the entities of the second group of entities of the external network 34 have the right to transmit information via the server 20 to one or a plurality of entities of the internal network 13. For example, the entity 31 of the external network 34 has the right to transmit information via the server 20 to one or a plurality of entities of the internal network 13.

For example, the entity 31 of the external network 34 is authenticated firstly with respect to the server 30 (e.g. via the network portal) and subsequently sends the second information item to the server 30 of the external network 34 (e.g. via the network portal).

In step 510, the second information item is received by the server 30 from the entity 31 (e.g. via the network connections 35 and 37).

In step 511, the second information item is sent from the server 30 to the server 20 (e.g. via the connection 23).

For example, the server 30 of the external network is further configured to send the second information item received by one of the authenticated entities of the second group of entities of the external network to the server 20. For example, the second information item is sent by the server 30 only to the server 20 when the entity 31 of the external network 34 has been authenticated with respect to the server 30.

In step 512, the second information item is received by the server 20 (e.g. via connection 23). This corresponds at least substantially to the above-described step 403. For example, the second information item is subsequently processed and/or integrated by the server 20.

In step 513, the second information item and/or an information item based on the second information item is retrieved by the server 10 from the server 20 (e.g. via connection 22).

In step 514, the second information item and/or the information item based on the second information item is sent by the server 20 to the server 10 in response to the retrieval in step 507 (e.g. via connection 22). This corresponds substantially to the above-described step 405.

In step 515, the second information item and/or the information item based on the second information item is received by the server 10 (e.g. via connection 22).

In step 516, the second information item and/or the information item based on the second information item is sent by the server 10 to the entity 11 (and e.g. the entity 12) (e.g. via the network connections 16 and 14).

In step 517, the second information item and/or the information item based on the second information item is received by the entity 11 (e.g. via the network connections 16 and 14).

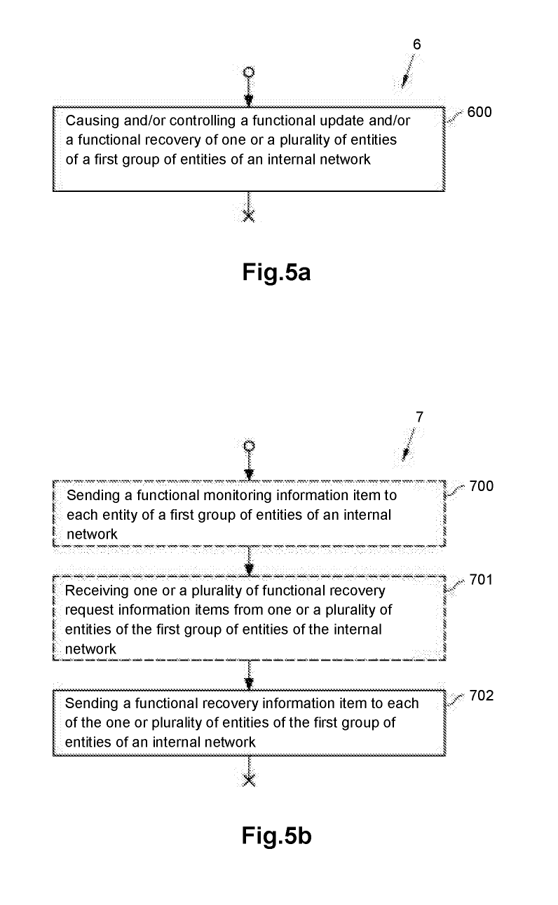

FIG. 5a shows a flow diagram 6 with steps of an exemplary embodiment of the method according to the second aspect of the invention which are performed and/or controlled by the server 10 according to FIG. 2b. For example, program instructions of a computer program stored in the program memory 120, which is executed by the processor 100, cause the server 10 to perform and/or control the steps of the flow diagram 6. The steps of the flow diagram 6 are described by way of example below in connection with the system 1 depicted in FIG. 1. The steps of the flow diagram 6 can for example also be part of an exemplary embodiment of the method according to the third aspect of the invention (e.g. together with the steps of the flow diagrams 4 and/or 5 described above).

In a step 600, a functional update and/or a functional recovery of one or a plurality of entities of a first group of entities of the internal network 13 is prompted and/or controlled.

In the present case, updating a function of an entity should for example be understood as one or a plurality of functions of the entity being changed, for example by adding a function to the entity, deactivating a function of the entity and/or activating a function of the entity. In the present case, recovering a function of an entity should for example be understood as one or a plurality of functions of the entity being transferred into a defined state (e.g. the delivered state). For example, updating and/or recovering a function of an entity can comprise storing a program in a memory of the entity and/or changing a program stored in a memory of the entity.

The first group of entities of the internal network for example comprises the entities of the internal network whose functional recovery and/or functional update can be prompted and/or controlled by the server 10. For example, the entities of the first group of entities of the internal network 13 comprise the entities 11, 11a, 11b and 12 of the internal network 13 (further possible entities of the first group of entities of the internal network 13 are not depicted). The entities of the first group of entities of the internal network 13 are preferably all entities of the internal network except for the server 10.

In the present case, causing and/or controlling a functional recovery and/or a functional update of one or a plurality of entities of a first group of entities of the internal network 13 should for example be understood as a functional recovery information item and/or a functional update information item being provided to the one or the plurality of entities of the first group of entities of the internal network such that the one or plurality of entities of the first group of entities of the internal network are capable of recovering and/or updating the function(s). For example, a corresponding functional recovery information item and/or a corresponding functional update information item is sent in step 600 by the server 10 to the one or plurality of entities of the internal network (e.g. via the network connections 14, 15 and 16 of the internal network 13).

The one or plurality of entities of the first group of entities of the internal network are for example the entities of the first group of entities whose function(s) are supposed to be recovered and/or updated. For example, the one or plurality of entities of the first group of entities are the entities of the first group of entities whose functional recovery and/or functional update should be prompted and/or controlled by the server 10.

FIG. 5b shows a flow diagram 7 with steps of an exemplary embodiment of the method according to the second aspect of the invention which are performed and/or controlled by the server 10 according to FIG. 2b. For example, program instructions of a computer program stored in the program memory 120, which is executed by the processor 100, cause the server 10 to perform and/or control the steps of the flow diagram 7. The steps of the flow diagram 7 are described by way of example below in connection with the system 1 depicted in FIG. 1. The steps of the flow diagram 7 can for example also be part of an exemplary embodiment of the method according to the third aspect of the invention (e.g. together with the steps of the flow diagrams 4 and/or 5 described above).

In an optional step 700, respective functional monitoring information items are sent by the server 10 to each entity of a first group of entities of the internal network (e.g. via the network connections 14, 15 and 16). As described above, the first group of entities of the internal network for example comprises the entities of the internal network whose functional recovery and/or functional update can be prompted and/or controlled by the server 10. For example, the entities of the first group of entities of the internal network 13 comprise the entities 11, 11a, 11b and 12 of the internal network 13 (further possible entities of the first group of entities of the internal network 13 are not depicted).

In the present case, a functional monitoring information item should for example be understood as any information item which is suitable for functional monitoring of an entity of the first group of entities of the internal network (e.g. is suitable to interact with a watchdog functionality of the entity of the first group of entities of the internal network). For example, the format of the functional monitoring information item is predefined.

For example, the respective functional monitoring information for each entity of the first group of entities of the internal network is at least partially the same. However, it is also conceivable for the respective functional monitoring information for each entity of the first group of entities of the internal network to be at least partially different.

For example, the entities 11, 11a, 11b and 12 of the first group of entities of the internal network respectively have one watchdog functionality. For example, the watchdog functionality monitors for the respective entity to determine whether a functional monitoring information item is received (e.g. within a certain time period) by the respective entity. If a functional monitoring information item is not received by the respective entity (e.g. within a certain time period), the watchdog functionality is prompted and/or controlled for example such that a functional recovery request information item is sent by the respective entity to the server 10.

For example, a functional monitoring information item is sent at regular and/or irregular intervals to each entity of the first group of entities of the internal network.

In an optional step 701, one or a plurality of functional recovery request information items are received by one or a plurality of entities of the first group of entities of the internal network 13 at the server 10. For example, a functional recovery request information item is received in step 701 by the entities 11 and 12 of the first group of entities of the internal network 13 (e.g. via the network connections 14 and 16 as well as 15 and 16).

In the present case, a functional recovery request information item should for example, as described above, be understood as any information item that is suitable for at least partially triggering the causing and/control of the functional recovery of the one or plurality of entities of the first group of entities of the internal network 13. For example, the format of the functional recovery request information item is predefined.

For example, each of the functional recovery request information items is generated and sent by respectively one of the one or plurality of entities of the first group of entities.

In a step 702, a respective functional recovery information item is sent to each entity of the one or plurality of entities of the first group of entities of the internal network 13. For example, the sending of the respective functional recovery information item to the entity of the one or plurality of entities of the first group of entities of the internal network 13 takes place at least partially as a function of the one or plurality of functional recovery request information items received in step 701. For example, a respective functional recovery information item is sent to each of the one or plurality of entities of the first group of entities of the internal network 13, from which a functional recovery request information item has been received in step 701.

For example, the respective functional recovery information item for the respective entity of the one or plurality of entities of the first group of entities of the internal network comprises a functional recovery program with program instructions which cause the respective entity of the first group of entities of the internal network 13 to recover one or a plurality of functions of the entity (e.g. cause to store a program in a memory of the entity and/or to change a program stored in a memory of the entity) when the functional recovery program is executed by one or a plurality of processors of the respective entity. An example of a functional recovery program is an installation program and/or an update program.

For example, the respective functional recovery information for the respective entity of the one or plurality of entities of the first group of entities of the internal network 13 comprises a functional recovery time and/or a functional recovery time period.

For example, the functional recovery time predefines a time at which the respective entity begins and/or concludes the functional recovery (e.g. the time at which the recovered function(s) is/are activated). For example, the functional recovery time period predefines a time period in which the respective entity begins and/or concludes the functional recovery (e.g. the time period in which the recovered function(s) is/are activated).

For example, the functional recovery time and/or the functional recovery time period for each of the one or plurality of entities of the first group of entities of the internal network is at least partially different.

For example, a first functional recovery information item is sent in step 702 with a first functional recovery time to the entity 11 of the internal network (e.g. via the network connections 16 and 14) and a second functional recovery information item is sent with a second functional recovery time that is different from the first to the entity 12 of the internal network (e.g. via the network connections 16 and 15).

Modern cities nowadays are growing very quickly and for the first time more than 5 billion people live in cities. The need for infrastructural measures is thus growing rapidly and the competition between cities is increasing. For example, the recording of data is necessary for these measures. This recording is very expensive and complex outdoors according to the prior art for example because secure infrastructure for the direct current-operated sensors is lacking. For example, batteries and solar panels have to be installed on the lamp posts in the prior art in order to operate various sensors. These sensors for example generate data which are not secured and not encrypted. Other solutions of the prior art are provided as internet-capable solutions. The generated and/or recorded data of the different solutions are also scattered and for example do not flow into a central database of the customer. The individual solutions known in the prior art for recording sensor data are for example further established independently of each other such that customers do not have to deal with various different interfaces. In the outdoors, the prior art is for example also lacking secure and easy to operate infrastructure for direct current-based sensors, devices and communications hubs to many smartphones and tablets and smart cars. However, the reliability of a possible infrastructure which forms the basis of a plurality of sensors and devices outdoors requires a certain level of security. The failure of such an infrastructure would mean the failure of all services connected thereto. Such an infrastructure thus not only has to provide the basic services, but also protect against failures and attacks and/or also be able to recover from failures and attacks (hackers, power and network failure). In this connection, the present invention is particularly advantageous because a suitable secure and reliable infrastructure for direct current-based lights, sensors, devices, Apps and web applications is provided outdoors which can be reliably, flexibly and cost-effectively used by many applications.

The present invention enables the provision of an infrastructure outdoors for lights, sensors, Apps, traffic and cloud services in smart cities.

An infrastructure can, amongst other things, comprise networked intelligent entities (e.g. devices for controlling a light means), an internal network (e.g. an M2M network of a telco such as DT) and one or a plurality of servers of zone 3. The sum of the entities, the internal network and the one or the plurality of servers of zone 3 for example results in an intelligent infrastructure. In this case, all intelligence can be in the infrastructure (e.g. intelligence for LED control, sensor control, streaming for Apps, etc.) such that the use of plug & play components as “dumb” sensors is possible.

For example, the present invention for example allows for a non-finished component to be connected to the infrastructure instead of a completed component (e.g. a complete light).

The entities of the internal network can be grouped in the infrastructure. A master has for example a 3G or LTE or 2G connection. Others are connected to the master. There is 1-n sensors for each entity of the internal network which are controlled by the respective entity. There can also be a connection to an external network here (e.g. a meshed network). An example of this would be “failure networks”. In catastrophic events, the entities of the internal network are for example part of another network (e.g. if 3G/networks and/or power should fail). An outdoor lighting system on a smart building also mainly comprises distributed components in buildings based on meshed networks.

A telco network is for example 1-n (there can also be a plurality of networks if it is international). For example, the telco network collects everything and connects to the one or the plurality of servers of zone 3.

The exemplary embodiments of the present invention described in this specification should also be understood as being disclosed in all combinations with each other. In particular, the description of a feature comprised of one embodiment, insofar as it is not explicitly otherwise stated, should, in the present case, not be understood as the feature being essential or significant for the function of the exemplary embodiment. The sequence of the method steps outlined in this specification in the individual flow diagrams is not mandatory, alternative sequences of the method steps are conceivable. The method steps can be implemented in a different manner, an implementation in software (by program instructions), hardware or a combination of both for implementing the method steps is thus conceivable. In the claims, the terms used such as “comprise”, “have”, “include”, “contain” and the like, do not exclude further elements or steps. The wording “at least partially” encompasses both the case of “partially” and the case of “completely”. The wording “and/or” should be understood as both the alternative and the combination being disclosed, i.e. “A and/or B” means “(A) or (B) or (A and B)”. A plurality of units, persons or the like means, in the context of this specification, a plurality of units, persons or the like. The use of the indefinite article does not exclude a plurality. An individual device can perform the functions of a plurality of units or devices mentioned in the claims. Reference numerals indicated in the claims must not be considered limitations of the means and steps used.

All references, including publications, patent applications, and patents cited herein are hereby incorporated by reference to the same extent as if each reference were individually and specifically indicated to be incorporated by reference and were set forth in its entirety herein.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method comprising:
receiving a first information item, wherein the first information item originates from one or a plurality of entities of an internal network,
providing the first information item and/or an information item based on the first information item at least partially as a function of an allocation of an information type of the first information item and/or the information item based on the first information item to a first group of entities of an external network such that the first information item and/or the information item based on the first information item is only obtainable by the entities of the first group of entities of the external network, wherein the first group of entities comprises a plurality of entities,
receiving a second information item, wherein the second information item originates from an entity of a second group of entities of the external network, and
providing the second information item and/or an information item based on the second information item such that the second information item is only obtainable by one or a plurality of entities of the internal network.

2. The method according to claim 1, wherein the provision of the first information item and/or the information item based on the first information item comprises storing of the first information item and/or the information item based on the first information in a first storage area, and wherein the provision of the second information item and/or the information item based on the second information item comprises storing of the second information item and/or the information item based on the second information item in a second storage area.

3. The method according to claim 2, wherein the first storage area is allocated to the first group of entities of the external network, and wherein the second storage area is allocated to the entities of the internal network.

4. The method according to claim 2, wherein the different storage areas are separated from other storage areas in terms of software and/or hardware.

5. The method according to claim 1, further comprising:
causing and/or controlling a functional recovery and/or a functional update of one or a plurality of entities of a first group of entities of the internal network.

6. The method according to claim 5, further comprising:
sending a functional monitoring information item to each entity of the first group of entities of the internal network,
receiving a functional recovery request information item from one or a plurality of entities of the first group of entities of the internal network, wherein the causing and/or controlling of the functional recovery of the one or plurality of entities of the first group of entities of the internal network takes place at least partially as a function of the one or plurality of functional recovery request information items received.

7. The method according to claim 6, wherein a functional monitoring information item is repeatedly sent to each entity of the first group of entities of the internal network.

8. A tangible computer-readable storage medium comprising a computer program, the computer program comprising program instructions which cause a device to at least partially perform and/or control:
receiving a first information item, wherein the first information item originates from one or a plurality of entities of an internal network,
providing the first information item and/or an information item based on the first information item at least partially as a function of an allocation of an information type of the first information item and/or the information item based on the first information item to a first group of entities of an external network such that the first information item and/or the information item based on the first information item is only obtainable by the entities of the first group of entities of the external network, wherein the first group of entities comprises a plurality of entities,
receiving a second information item, wherein the second information item originates from an entity of a second group of entities of the external network, and
providing the second information item and/or an information item based on the second information item such that the second information item is only obtainable by one or a plurality of entities of the internal network.

9. A system comprising,
one or a plurality of servers, wherein the servers respectively comprise at least one processor and at least one memory including one or a plurality of server programs with program instructions, wherein the memory and the program instructions are configured to, together with the processor, cause the servers to perform and/or control:
receiving a first information item, wherein the first information item originates from one or a plurality of entities of an internal network,
providing the first information item and/or an information item based on the first information item at least partially as a function of an allocation of an information type of the first information item and/or the information item based on the first information item to a first group of entities of an external network such that the first information item and/or the information item based on the first information item is only obtainable by the entities of the first group of entities of the external network, wherein the first group of entities comprises a plurality of entities,
receiving a second information item, wherein the second information item originates from an entity of a second group of entities of the external network, and
providing the second information item and/or an information item based on the second information item such that the second information item is only obtainable by one or a plurality of entities of the internal network.

10. The system according to claim 9, wherein the provision of the first information item and/or the information item based on the first information item comprises storing of the first information item and/or the information item based on the first information in a first storage area, and wherein the provision of the second information item and/or the information item based on the second information item comprises storing of the second information item and/or the information item based on the second information item in a second storage area.

11. The system according to claim 10, wherein the first storage area is allocated to the first group of entities of the external network, and wherein the second storage area is allocated to the entities of the internal network.

12. The system according to claim 10, wherein the different storage areas are separated from other storage areas in terms of software and/or hardware.

13. The system according to claim 9, wherein different information types are respectively at least partially allocated to different groups of entities of the external network.

14. The system according to claim 9, wherein the second information item and/or an information item based on the second information item is only provided if the second information item originates from an entity of the second group of entities of the external network.

15. The system according to claim 9, wherein the entities of the first group of entities of the external network are at least partially different from the entities of the second group of entities of the external network.

16. The system according to claim 9, wherein the second information item and/or the information item based on the second information item comprises a control information item for controlling one or a plurality of entities of the internal network.

17. The system according to claim 9, wherein the memory and the program instructions are configured to, together with the processor, further cause the servers to perform and/or control:
causing and/or controlling a functional recovery and/or a functional update of one or a plurality of entities of a first group of entities of the internal network.

18. The system according to claim 17, wherein the memory and the program instructions are configured to, together with the processor, further cause the servers to perform and/or control:
sending a functional monitoring information item to each entity of the first group of entities of the internal network,
receiving a functional recovery request information item from one or a plurality of entities of the first group of entities of the internal network, wherein the causing and/or controlling of the functional recovery of the one or plurality of entities of the first group of entities of the internal network takes place at least partially as a function of the one or plurality of functional recovery request information items received.

19. The system according to claim 18, wherein a functional monitoring information item is repeatedly sent to each entity of the first group of entities of the internal network.

20. The system according to claim 17, wherein the causing and/or controlling of the functional recovery and/or functional update of the one or plurality of entities of the first group of entities of the internal network comprises:
sending a functional recovery information item and/or a functional update information item to each of the one or plurality of entities of the first group of entities of the internal network.

21. The system according to claim 20, wherein the respective functional recovery information item comprises a respective functional recovery program and/or the respective functional update information item comprises a respective functional update program.

22. The system according to claim 20, wherein the respective functional recovery program comprises program instructions which cause the respective entity of the first group of entities of the internal network to perform the functional recovery when the functional update program is executed by one or a plurality of processors of this respective entity, and/or wherein the respective functional update program comprises program instructions which cause the respective entity of the first group of entities of the internal network to perform the functional update when the functional update program is executed by one or a plurality of processors of this respective entity.

23. The system according to claim 20, wherein the functional recovery information for each of the one or plurality of entities of the first group of entities of the internal network respectively predefines a functional recovery time and/or a functional recovery time period, and/or wherein the functional update information for each of the one or plurality of entities of the first group of entities of the internal network respectively predefines a functional update time and/or a functional update time period.

24. The system according to claim 9, wherein the system comprises a first server and a second server,
wherein the first server comprises at least one processor and at least one memory including one or a plurality of server programs with program instructions, wherein the memory and the program instructions are configured to, together with the processor, cause the first server to perform and/or control:
receiving a first information item, wherein the first information item originates from one or a plurality of entities of an internal network,
providing the first information item and/or an information item based on the first information item at least partially as a function of an allocation of an information type of the first information item and/or the information item based on the first information item to a first group of entities of an external network such that the first information item and/or the information item based on the first information item is only obtainable by the entities of the first group of entities of the external network, wherein the first group of entities comprises a plurality of entities,
receiving a second information item, wherein the second information item originates from an entity of a second group of entities of the external network, and
providing the second information item and/or an information item based on the second information item such that the second information item is only obtainable by one or a plurality of entities of the internal network, and,
wherein the second server comprises at least one processor and at least one memory including one or a plurality of server programs with program instructions, wherein the memory and the program instructions are configured to, together with the processor, cause the second server to perform and/or control:
causing and/or controlling a functional recovery and/or a functional update of one or a plurality of entities of a first group of entities of the internal network.
